(19) United States
(12) Patent Application Publication
(10) Pub. No.: US 2005/0074635 A1
(43) Pub. Date: Apr. 7, 2005

(54) Information recording medium and method of manufacturing glass substrate for the information recording medium, and glass substrate for the information recording medium, manufactured using the method

(75) Inventors: Kazuishi Mitani, Itami-shi (JP); Hiroshi Komura, Itami-shi (JP)

Correspondence Address: COHEN, PONTANI, LIEBERMAN & PAVANE, 551 FIFTH AVENUE, SUITE 1210, NEW YORK, NY, 10176, US

(73) Assignee: Nippon Sheet Glass Co., Ltd., Osaka-shi (JP)

(21) Appl. No.: 10/392,248

(22) Filed: Mar. 19, 2003

(30) Foreign Application Priority Data
Mar. 19, 2002 (JP) 2002-076288

(51) Int. Cl. G11B 5/66

(52) U.S. Cl. 428/694 ST; 428/694 R

(57) ABSTRACT

There is provided an information recording medium and a method of manufacturing a glass substrate for information recording media as well as a glass substrate manufactured using the method, according to which the take-off height (TOH) of a HDD for example can be made low. The surface shape in a predetermined region of an information recording medium is measured using an optical interferometer or an atomic force microscope. The measured surface shaped is subjected to line analysis along the circumferential direction of the information recording medium. A calculation is made of the product PSD×f of PSD corresponding to a predetermined wavelength ν and the reciprocal of the predetermined wavelength ν. The maximum value of the calculated PSD is controlled to not more than a predetermined value. As a result, the TOH can be made low by reducing waviness which hinders the magnetic head of a HDD or the like from stably flying.

### BACKGROUND OF THE INVENTION

1. Field of the Invention

The present invention relates to an information recording medium and a method of manufacturing a glass substrate for the information recording medium, and a glass substrate for the information recording medium, manufactured using the method. In particular, the present invention relates to an information recording medium that has been evaluated using a power spectrum, and a method of manufacturing a glass substrate for the information recording medium, and a glass substrate for the information recording medium, manufactured using the method.

2. Description of the Related Art

In recent years, there has been remarkable progress in the digitization of information, and to record digitized information on information recording media, various types of information recording devices have been developed and manufactured. There have been very rapid improvements and advances in such information recording media, specifically there have been increases of approximately 10 to 20% per year in the information recording capacity of information recording media, the recording speed and the playback speed of information recording devices. Amid this situation, the information recording devices most widely used at present are hard disk drives (hereinafter referred to as “HDD” or “HDDs”), and the rate of improvements and advances has been even faster for HDDs than for other information recording media.

In hard disk media (hereinafter occasionally referred to as “disk” or “disks”), an information recording layer is formed on a glass substrate for hard disks, and digitized information is recorded on (or written into) the information recording layer.

The load/unload methods used by magnetic heads of HDDs include the CSS (contact start/stop) method or the ramp load method. In the CSS method, the magnetic head flies over an information recording region of the disk while the disk is rotating, and slides over a CSS zone of the disk when the disk starts or stops rotating. In the CSS method, the magnetic head and the disk are in contact with each other while the disk is stopping.

The CSS zone of the disk is a region where uniform undulations of height several tens of nm are intentionally provided, and is generally along the inner or outer periphery of the disk.

In the ramp load method, the magnetic head flies over the disk while the disk is rotating, and is stored in a storage position when the magnetic head stops rotating. In the ramp load method, the magnetic head and disk do not contact with each other even if the disk is stopping.

Hereinafter, the minimum flying height of the magnetic head is referred to as the “take-off height” (hereinafter abbreviated as “TOH” as required). If the TOH is made low, then the flying height can also be made low. The take-off height is sometimes called the touch-down height.

In the CSS method or the ramp load method, while the hard disk is rotating, the magnetic head flies over the information recording region of the hard disk with the TOH. Therefore, to achieve high information recording density, it is required to make the TOH low.

However, when carrying out recording information on a disk or playing back the recorded information using a magnetic head, if there are large undulations on the surface of the hard disk, then the magnetic head will be prone to contacting or colliding with large projections on the surface of the hard disk. In this case, head crashes will be prone to occurring due to wobbling of the magnetic head during flight.

Moreover, even before a head crash occurs, so-called thermal asperity in which the magnetic head detects an abnormal signal due to heat generated through the contacts or collisions will be prone to occurring.

In particular, recently, to carry out reading of recorded information with high accuracy, MR (magneto-resistive) heads and GMR (giant MR) heads as magnetic heads have been mainly used. With such magnetic heads, thermal asperity becomes yet more prone to occurring. There are thus demands for magnetic heads of such types capable of reading recording information with high accuracy, according to which thermal asperity is not prone to occurring.

Although conventionally aluminum substrates have been mainly used as hard disk substrates, at present a changeover to glass substrates is taking place. Glass substrates used as hard disk substrates allow high precision polishing, thus enabling a reduction in the head flying height. As a result, the gap between the glass substrate and the magnetic head can be reduced so that the magnetic head can perform reading of recorded information with high accuracy. Thus, glass substrates for information recording media are required to have high surface flatness or surface smoothness, and further high rigidity.

Information recording media using such glass substrates are manufactured by carrying out manufacturing steps described below in the order stated.

FIG. 10 is a flowchart showing a conventional method of manufacturing an information recording medium using a glass substrate for information recording media.

In FIG. 10, in step 21, a glass sheet made of an aluminosilicate parent material glass is produced, and a donut-shaped workpiece is cut out from this glass sheet (workpiece cutting-out step).

Next, the inner and outer peripheral edge surfaces of the workpiece are subjected to predetermined chamfering, and to polishing using rotating nylon brushes, an alumina abrasive grain polishing agent, or the like (edge surface polishing step, step S22), and then the information recording surfaces of the workpiece are subjected to polishing using a cerium oxide slurry and polishers made of a hard fabric (recording surface polishing step, step S23).

The workpiece is then subjected to chemical strengthening treatment, followed by washing (chemical strengthening step), to obtain a glass substrate for information recording media (step S24). If necessary, the thus obtained glass substrate is examined with regard to surface flatness and so on.

Then, a magnetic film or photo-recordable film is deposited on the glass substrate to form an information recording medium (film deposition step, step S25), and then a predetermined examination is carried out (examination step, step S26), thus completing the manufacture of the information recording medium.

It should be noted that, to evaluate the surface flatness of the glass substrates or the information recording media, the values of, for example, the average roughness Ra, the mean square roughness RMS, and the average roughness of waviness or minute waviness as measured only for a particular wavelength range with a cutoff, and so on are measured.

Here, the average roughness Ra is as stipulated as the center line average roughness in JIS B0601 in the JIS standards, and is the mean of the absolute value of the deviation to the measured roughness curve from the center line. The mean square roughness RMS is as stipulated in JIS B0601 as the root-mean square roughness RMS in the JIS standards, and is the square root of the mean over a sampling length of the integral over the sampling length of the square of the deviation to the roughness curve from the center line.

Moreover, a method has been proposed in which, instead of the polishing using polishers of step S23 mentioned above, polishing is carried out by shaving off the surface layer of a glass substrate for information recording media using artificial leather called “suede” (e.g. Japanese Laid-open Patent Publication (Kokai) No. 2000-53450) (first prior art). According to this first prior art, it is asserted that an information recording medium using a glass substrate for information recording media having high surface smoothness can be manufactured.

Furthermore, in an examination step after step S24 or the examination step S26 mentioned above, instead of the method in which waviness, minute waviness and so on are evaluated by wavelength, as a method of evaluating waviness components of wavelength longer than this, a method has been proposed in which evaluation is carried out using the average height of minute waviness of wavelength 2 to 4,000 μm, or the average height of waviness of wavelength 300 to 5,000 μm, over a predetermined region of area 50 to 4,000 μm² as an index (e.g. Japanese Laid-open Patent Publication (Kokai) No. 2000-348330, Japanese Laid-open Patent Publication (Kokai) No. 2000-348331, and Japanese Laid-open Patent Publication (Kokai) No. 2000-348332) (second prior art).

Moreover, in Japanese Laid-open Patent Publication (Kokai) No. 2000-31224, it is proposed that the surface flatness be evaluated using the power spectral density (hereinafter referred to as “PSD”), which is a function of the wavelength ν or the frequency f, to evaluate the minute waviness (third prior art).

In the meanwhile, with regard to surface flatness of a disk for HDDs, components of waviness on the disk, which hinder a magnetic head from stably flying, include: “waviness”, which is an undulating shape of wavelength approximately several mm to 20 mm, “minute waviness”, which is an undulating shape of wavelength approximately 2 to 4,000 μm, and “micro-roughness”, which is an undulating shape of wavelength not more than 100 μm, and so on (hereinafter, these will be referred to collectively merely as “waviness components”). It should be noted, however, that there are no precise definitions or standards stipulated with regard to the above wavelength ranges.

However, if, as in the first prior art, merely the value of the average roughness Ra, the mean square roughness RMS, the average roughness of the waviness or minute waviness with a wavelength cutoff, or the like is made small, then the surface of the glass substrate for information recording media cannot be made to be sufficiently flat. This is because, even though polishing or the like is carried out, waviness components having various periods are superimposed on one another on the surface of a glass substrate for information recording media. Thus, there is a limit to how much the flying height of a magnetic head can be lowered.

With such waviness components superimposed on one another, even if the value of the average roughness Ra, the mean square roughness RMS, the average roughness of the waviness or minute waviness with a wavelength cutoff, or the like is merely measured to evaluate the surface flatness, then the surface flatness cannot be sufficiently described.

In the second prior art described above, the value of the average height of waviness components is used in the evaluation of the surface flatness, but because this is merely an average value, it is not possible to sufficiently describe the contribution from a waviness component of a particular wavelength.

Furthermore, the average value is obtained by averaging in directions in two dimensions, and hence it is not possible to separate the contribution from the flying direction (the circumferential direction of the information recording medium) of the magnetic head of, for example, a HDD and the contribution from the direction perpendicular to the head flying direction (the radial direction of the information recording medium) of the magnetic head when describing the surface flatness.

The separation of the above two contributions is important in evaluating flying characteristics of a magnetic head of a disk, in particular a disk on which circumferential texture is formed. This is because a surface formed with circumferential texture has waviness components which differ between the head flying direction (the circumferential direction) and the direction perpendicular thereto (the radial direction), so that the waviness components averaged in directions in two dimensions cannot sufficiently describe the waviness components which hinder the magnetic head from stably flying.

Moreover, in the third prior art, in general the PSD function as used for the evaluation has a slope of 1/f (or in some cases 1/f²) as the baseline thereof (FIG. 11), and hence it is possible to carry out a comparison between a plurality of PSD functions of the PSD intensity (power) at a particular wavelength. However, it is difficult to carry out a quantitative comparison of the PSD intensity (power) over a wavelength region around a particular wavelength for a single PSD function. It is thus not easy to evaluate the TOH.

### SUMMARY OF THE INVENTION

It is an object of the present invention to provide an information recording medium and a method of manufacturing a glass substrate for the information recording medium, and a glass substrate for the information recording medium, according to which the TOH can be made low by reducing waviness which hinders the magnetic head of a HDD or the like from stably flying.

To attain the above object, in a first aspect of the present invention, there is provided an information recording medium comprising a substrate, and at least one recording layer formed on the substrate, wherein the at least one recording layer has a surface shape thereof measured at a predetermined wavelength in a predetermined region of a surface thereof, and a maximum value of a product of a power spectral density corresponding to the predetermined wavelength and a reciprocal of the predetermined wavelength is not more than a predetermined value.

According to the above constitution, the maximum value of the product of the power spectral density corresponding to the predetermined wavelength and the reciprocal of the predetermined wavelength is not more than a predetermined value. As a result, waviness components which hinder the magnetic head of a HDD or the like from stably flying can be reduced, and hence an information recording medium having a low TOH can be provided.

Preferably, the surface shape is measured using an interferometer and the predetermined region has an area in a range of 0.1 mm to 5 mm square, and the predetermined value is not more than 1600 cm². As a result, the TOH can be made to be not more than 4.5 nm since the predetermined value is not more than 1600 cm².

More preferably, the predetermined value is not more than 1300 cm². As a result, the TOH can be made not more than 4.0 nm since the predetermined value is not more than 1300 cm².

Alternatively, the predetermined region has an area in a range of 10 μm to 200 μm square, and the predetermined value is not more than 1100 cm². As a result, the TOH can be made to be not more than 4.5 nm since the predetermined value is not more than 1100 cm².

Preferably, the predetermined value is not more than 900 cm². As a result, the TOH can be made to be not more than 4.0 nm since the predetermined value is not more than 900 cm².

Alternatively, preferably, the surface shape is measured by scanning the surface of the at least one recording layer with a probe of an atomic force microscope, and the predetermined region has an area in a range of 1 μm to 50 μm square, and the predetermined value is not more than 100 nm². As a result, the TOH can be made to be not more than 4.5 nm since the predetermined value is not more than 100 nm².

More preferably, the predetermined value is not more than 80 nm². As a result, the TOH can be made to be not more than 4.0 nm since the predetermined value is not more than 80 nm².

Also preferably, the substrate has a main surface, and circumferential texture is formed on the at least one recording layer or the main surface of the substrate. As a result, the information recording density can be improved since the at least one recording layer has a magnetic anisotropy in the circumferential direction and the radial direction of the information recording medium.

To attain the above object, in a second aspect of the present invention, there is provided a method of manufacturing a glass substrate for information recording media, the glass substrate having at least one recording layer formed thereon, comprising a polishing step of polishing at least one surface of a glass substrate-using at least one polishing member made of a processed resin having a 100% modulus in a range of 7,840 to 24,500 kPa (80 to 250 kg/cm²)

Note that the 100% modulus represents a force required for extending a test piece having a cross sectional area of 1 cm² to twice a length of the test piece.

According to the above constitution, waviness components can be substantially eliminated, and hence the occurrence of head crashes and thermal asperity can be prevented, and thus the TOH can be made to be low.

Preferably, the at least one polishing member is rotated at 0.0333 to 0.25 per second (2 to 15 rpm). As a result, the occurrence of waviness components and fine scratches on the glass substrate can be reduced.

Preferably, in the polishing step, a slurry containing a polishing agent that has a maximum particle diameter in a range of 1 to 3 μm is used. As a result, waviness components on the glass substrate can be substantially eliminated, and moreover the occurrence of fine scratches can be prevented.

Preferably, in the polishing step, a slurry containing a polishing agent that has a content of particles having a maximum particle diameter in a range of 1 to 3 μm of not more than 10% of mass of slurry solids is used. As a result, waviness components on the glass substrate can be substantially eliminated, and moreover the occurrence of fine scratches can be prevented.

Preferably, in the polishing step, a slurry containing silica having a particle diameter in a range of 0.01 to 1 μm is used. As a result, waviness components on the glass substrate can be substantially eliminated, and moreover the occurrence of fine scratches can be prevented. And moreover, shock given by a polishing agent on the glass substrate can be reduced.

Preferably, the at least one polishing member made of a processed resin having a 100% modulus in a range of 9,800 to 19,600 kPa (100 to 200 kg/cm²). As a result, waviness components on the glass substrate can be substantially eliminated, and the occurrence of head crashes and thermal asperity can be prevented, and thus the TOH can be made to be low.

To attain the above object, in a third aspect of the present invention, there is provided a glass substrate for information recording media manufactured by a method of manufacturing a glass substrate for information recording media according to the second aspect, wherein the at least one recording layer has a surface shape thereof measured at a predetermined wavelength in a predetermined region of a surface thereof, and a maximum value of a product of a power spectral density corresponding to the predetermined wavelength and a reciprocal of the predetermined wavelength is not more than a predetermined value.

According to the above constitution, the maximum value of the product of the power spectral density corresponding to the predetermined wavelength and the reciprocal of the predetermined wavelength is not more than a predetermined value. As a result, in an information recording medium in which at least one magnetic layer is formed on the glass substrate, waviness components which hinder the magnetic head of a HDD or the like from stably flying can be reduced, and hence an information recording medium having a low TOH can be provided.

Preferably, the surface shape is measured using an interferometer and the predetermined region has an area in a range of 0.1 mm to 5 mm square, and the predetermined value is not more than 1600 cm². As a result, in an information recording medium in which at least one magnetic layer is formed on the glass substrate, the TOH can be made to be not more than 4.5 nm since the predetermined value is not more than 1600 cm².

More preferably, the predetermined value is not more than 1300 cm²⁶. As a result, in an information recording medium in which at least one magnetic layer is formed on the glass substrate, the TOH can be made to be not more than 4.0 nm since the predetermined value is not more than 1300 cm².

Alternatively, the predetermined region has an area in a range of 10 μm to 200 μm square, and the predetermined value is not more than 1100 cm². As a result, in an information recording medium in which at least one magnetic layer is formed on the glass substrate, the TOH can be made to be not more than 4.5 nm since the predetermined value is not more than 1100 cm².

Preferably, the predetermined value is not more than 900 cm². As a result, in an information recording medium in which at least one magnetic layer is formed on the glass substrate, the TOH can be made to be not more than 4.0 nm since the predetermined value is not more than 900 cm².

Alternatively, preferably, the surface shape is measured by scanning the surface of the at least one recording layer with a probe of an atomic force microscope, and the predetermined region has an area in a range of 1 μm to 50 μm square, and the predetermined value is not more than 100 nm². As a result, in an information recording medium in which at least one magnetic layer is formed on the glass substrate, the TOH can be made to be not more than 4.5 nm since the predetermined value is not more than 100 nm².

More preferably, the predetermined value is not more than 80 nm². As a result, in an information recording medium in which at least one magnetic layer is formed on the glass substrate, the TOH can be made to be not more than 4.0 nm since the predetermined value is not more than 80 nm².

Also preferably, the substrate has a main surface, and circumferential texture is formed on the main surface of the substrate. As a result, in an information recording medium in which at least one magnetic layer is formed on the glass substrate, the information recording density can be improved since the at least one recording layer has a magnetic anisotropy in the circumferential direction and the radial direction of the information recording medium.

As described in detail above, in the information recording medium according to the first aspect or the glass substrate for information recording media according to the third aspect, the product of the power spectral density corresponding to the predetermined wavelength and the reciprocal of the predetermined wavelength is not more than a predetermined value. As a result, an information recording medium or glass substrate for information recording media having a low TOH can be provided.

Moreover, in an evaluation method used in the method of manufacturing a glass substrate for information recording media according to the second aspect, the TOH can be evaluated with ease without anything contacting the surface of the medium to be evaluated.

Furthermore, according to the method of manufacturing a glass substrate for information recording media according to the second aspect, the at least one surface of the glass substrate is polished using the at least one polishing member made of a processed resin having a 100% modulus in a range of 7,840 to 24,500 kPa. As a result, a glass substrate for information recording media having good medium characteristics can be manufactured.

The above and other objects, features and advantages of the invention will become more apparent from the following detailed description taken in conjunction with the accompanying drawings.

### BRIEF DESCRIPTION OF THE DRAWINGS

FIG. 1 is a flowchart showing a method of manufacturing an information recording medium according to an embodiment of the present invention;

FIG. 2 is a graph showing the relationship between measured wavelength ν and PSD×f;

FIG. 3 is a graph showing the relationship between resin hardness (100% modulus) and a maximum value of PSD×f;

FIG. 4 is a graph showing the relationship between the rotational speed of a carrier and the maximum value of PSD×f;

FIG. 5 is a graph showing the relationship between maximum particle diameter of a polishing agent and the maximum value of PSD×f;

FIG. 6 is a graph showing the relationship between proportion of the polishing agent having a particle diameter of at least 1 μm to slurry solids and maximum value of PSD×f;

FIGS. 7A and 7B are graphs showing the relationships between a measured index of waviness as measured by using an optical interferometer with a wavelength ν range of 0.1 to 5 mm, and TOH, in which FIG. 7A shows the relationship between mean waviness Wa (nm) and the TOH (nm), and FIG. 7B shows the relationship between the maximum value of PSD×f (cm²) and the TOH (nm);

FIGS. 8A and 8B are graphs showing the relationships between a measured index of waviness as measured by using an optical interferometer with a wavelength ν range of 10 to 200 μm, and TOH, in which FIG. 8A shows the relationship between the mean waviness Wa (nm) and the TOH (nm), and FIG. 8B shows the relationship between the maximum value of PSD×f (cm²) and the TOH (nm);

FIGS. 9A and 9B are graphs showing relationships between a measured index of waviness as measured with a probe by using an atomic force microscope with a wavelength ν range of 1 to 50 μm, and TOH, in which FIG. 9A shows the relationship between the average roughness Ra (nm) and the TOH (nm), and FIG. 9B shows the relationship between the maximum value of PSD×f (nm²) and the TOH (nm);

FIG. 10 is a flowchart showing a conventional method of manufacturing an information recording medium; and

FIG. 11 is a graph showing the relationship between measured wavelength ν and PSD.

### DETAILED DESCRIPTION OF THE PREFERRED EMBODIMENTS

The present inventors carried out assiduous studies to attain the above object, and as a result discovered that in the case of an information recording medium that is comprised of a substrate, and at least one recording layer is formed on the substrate, if the shape of undulations on the surface of the recording layer is measured at a predetermined wavelength in a predetermined region of the surface thereof, and the product of a power spectral density corresponding to the predetermined wavelength and the reciprocal of the predetermined wavelength is not more than a predetermined value, then the presence of waviness components that hinder the magnetic head of a HDD for example can be evaluated with ease, whereby an information recording medium having a low TOH can be provided.

To attain the above object, in a first aspect of the present invention, there is provided an information recording medium comprising a substrate, and at least one recording layer formed on the substrate, wherein the at least one recording layer has a surface shape thereof measured at a predetermined wavelength in a predetermined region of a surface thereof, and a maximum value of a product of a power spectral density corresponding to the predetermined wavelength and a reciprocal of the predetermined wavelength is not more than a predetermined value.

According to the above constitution, the maximum value of the product of the power spectral density corresponding to the predetermined wavelength and the reciprocal of the predetermined wavelength is not more than a predetermined value. As a result, waviness components can be reduced hinders the magnetic head of a HDD or the like from stably flying, and hence an information recording medium having a low TOH can be provided.

Furthermore, the present inventors discovered that if the method of manufacturing a glass substrate for an information recording medium, the substrate having a recording layer formed thereon, further comprises polishing at least one surface of the glass substrate using a polishing member made from a resin having a 100% modulus in a range of 7,840 to 24,500 kPa (80 to 250 kg/cm²), then waviness components which hinder the magnetic head of a HDD from stably flying can be substantially reduced, and hence the occurrence of head crashes and thermal asperity can be prevented, and thus the TOH can be made to be low.

The present invention was accomplished based on the above discoveries.

A method of manufacturing an information recording medium according to the present invention will now be described in detail with reference to the drawings showing a preferred embodiment thereof.

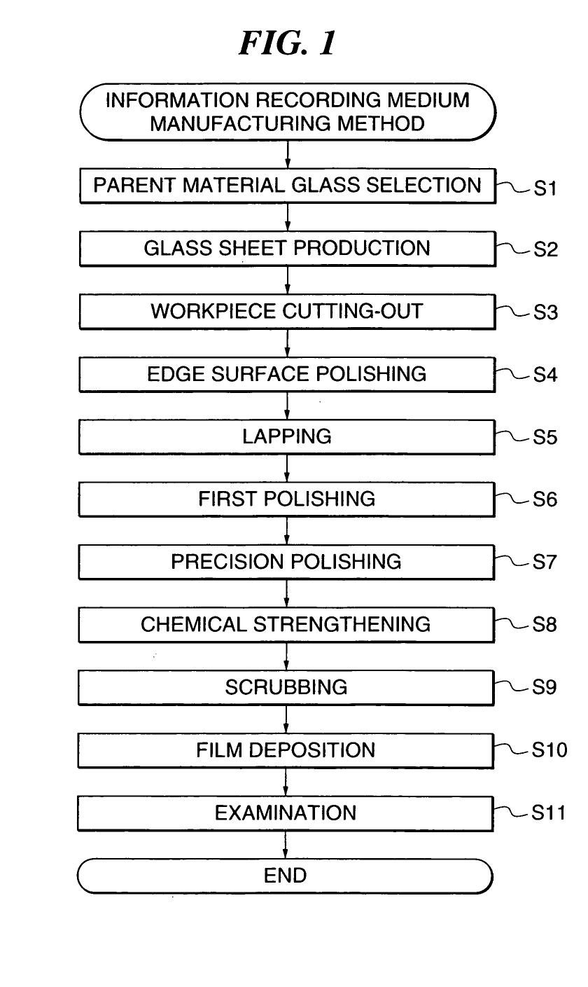

FIG. 1 is a flowchart showing the method of manufacturing the information recording medium according to the present embodiment. It should be noted that the present invention is not limited to the described embodiment.

Parent Material Glass Selection Step (Step S1)

First, a parent material glass for a glass substrate for manufacturing an information recording medium is selected, for example a soda lime glass having SiO₂, Na₂O and CaO as principal components thereof, an aluminosilicate glass having SiO₂, Al₂O₃, Na₂O and Li₂O as principal components thereof, a borosilicate glass, an Li₂O—SiO₂ glass, an Li₂O—Al₂O₃—SiO₂ glass, or an RO—Al₂O₃—SiO₂ glass (R═Mg, Ca, Sr, Ba, Zn, Ni, Mn, etc.); the parent material glass may also be, for example, a glass for chemical strengthening having a composition such as above but additionally containing ZrO₂, TiO₂, SiO₂ or the like, or a crystallized glass that is not chemically strengthened.

It is preferable for the parent material glass to be a crystallized glass, this being from the perspective of the surface smoothness being high, surface working being easy to carry out, and the elastic modulus, rigidity and strength being high.

From the perspective of the surface smoothness being high, it is more preferable for the parent material glass to be an amorphous glass than a crystallized glass, and from the perspective of the mechanical strength, the shock resistance and so on being high, it is particularly preferable for the parent material glass to be an aluminosilicate glass.

Moreover, from the perspective of it being possible to carry out modification of the surface layer of the glass substrate, it is preferable for the parent material glass to be a glass for chemical strengthening treatment, but the parent material glass may also be a chemically strengthened glass in which a compressive stress layer has already been formed at the surface layer of the parent material glass through chemical strengthening treatment. It should be noted, however, that the parent material glass is not particularly limited to being as described above.

Glass Sheet Production Step (Step S2)

A glass sheet of a predetermined thickness is produced from the parent material glass selected for a glass substrate. Any method may be used to produce the glass sheet, for example a float process in which the parent material glass is formed into a sheet on molten metal, a down draw method in which the parent material glass is formed into a sheet using gravity, or a redraw method in which a parent material glass ingot is remelted and formed into a sheet.

Workpiece Cutting-Out Step (Step S3)

The glass sheet, which is for example a sheet of aluminosilicate glass that has been produced using a float method, is simultaneously cut along the inner and outer peripheries thereof using hard metal or diamond cutters. As a result, a donut-shaped workpiece having good concentricity between the inner and outer peripheries thereof can be formed. Note that the outside diameter of the workpiece is made to be slightly larger than the outside diameter will be in the final product dimensions of the glass substrate, and the inside diameter of the workpiece is made to be slightly smaller than the inside diameter will be in the final product dimensions of the glass substrate.

The method of cutting out the donut-shaped workpiece from the glass sheet is not limited to being the above method, but rather may also be, for example, a method in which the glass sheet is first cut along only the outer periphery, and then a hole is bored in the glass sheet along the inner periphery using a cylindrical diamond grindstone, or a method in which the glass sheet is first pressed out into a disk shape having a desired outside diameter using a pressing method, and then a hole is bored in the glass sheet along the inner periphery using a cylindrical diamond grindstone.

Edge Surface Polishing Step (Step S4)

Next, inner and outer peripheral edge surfaces of the cut-out workpiece or the glass substrate are subjected to grinding, to precisely adjust the dimensions (inside and outside diameters) of the workpiece to the required product dimensions. Grindstones having diamond abrasive grains attached thereto are used in the grinding. The grinding is comprised of two stages, namely grinding using grindstones having diamond abrasive grains of roughness #325 attached thereto, and then grinding using grindstones having diamond abrasive grains of roughness #500 attached thereto.

At the same time as this grinding, the inner and outer peripheral edge surfaces are subjected to chamfering using grindstones which are designed or adapted so as to make the glass substrate product have predetermined dimensions. Note that the grinding and the chamfering may be carried out either simultaneously or separately. Moreover, in accordance with the required product quality, the roughness of the diamond abrasive grains may be different to the above. Furthermore, it goes without saying that if the workpiece is cut out in the workpiece cutting-out step S3 to dimensions close to the required glass substrate product dimensions, then it may not be necessary to carry out two stages of grinding in the present step, but rather one step may suffice.

Next, the chamfered inner and outer peripheral edge surfaces are subjected to polishing using a slurry containing cerium oxide as a polishing agent, to make the chamfered inner and outer peripheral edge surfaces smoother.

Lapping Step (Step S5)

Next, before subjecting the information recording surfaces (upper and lower surfaces) of the workpiece to precision polishing, described later, the information recording surfaces of the workpiece are subjected to rough polishing (lapping). This rough polishing is made in order to adjust the thickness of the workpiece and improve the surface flatness of the workpiece and hence reduce waviness components as well as eliminate cracks, scratches and other defects that will have inevitably arisen on the information recording surfaces of the workpiece.

Specifically, upper and lower information recording surfaces of the workpiece are simultaneously subjected to lapping using a polishing machine, while feeding in, between the metal plates of the polishing machine and the information recording surfaces of the workpiece, a slurry containing alumina abrasive grains and having a solids concentration of approximately 20 mass % as loose abrasive grains (a polishing agent). The lapping is comprised of two stages, namely lapping using a slurry containing alumina abrasive grains of roughness #600, and then lapping using a slurry containing alumina abrasive grains of roughness #1000.

It should be noted that it is also possible to carry out the lapping before the edge surface polishing of step S4, described earlier, or to carry out the first stage of the lapping before the edge surface polishing and then carry out the second stage of the lapping after the edge surface polishing.

In the lapping step of the present manufacturing method, the lapping rate is high, and hence the workpiece is generally lapped until its thickness becomes close to the final thickness of the glass substrate product.

Moreover, in the case that the thickness of the parent glass is close to the final thickness of the product, it may not be necessary to carry out two stages of lapping, in which case the lapping may be carried out in one stage using a slurry containing alumina abrasive grains of roughness rougher than #600. Moreover, instead of lapping using a slurry, fixed grindstones having diamond abrasive grains or alumina abrasive grains embedded therein may be used to perform lapping on the recording surfaces of the workpiece.

The polishing agent and slurry will become attached to the workpiece during the lapping, and hence after the lapping the workpiece is washed using water, a detergent or the like. During this washing, it is preferable to subject the workpiece to ultrasound of a suitable frequency. As a result, the polishing agent and slurry can be removed from the surfaces of the workpiece more easily.

It should be noted that the present step may be omitted in accordance with the degree of surface flatness (i.e. the amplitude of waviness components) required of the glass substrate product.

First Polishing Step (Step S6)

Next, the information recording surfaces of the workpiece are subjected to first polishing using a polishing agent composed of a slurry having cerium oxide as a principal component thereof, to improve surface roughness due to undulations that arose on the surfaces of the workpiece during the lapping, and eliminate cracks, scratches and so on can be eliminated. The slurry contains lanthanide oxide (for example, cerium oxide and lanthanum oxide) of concentration approximately 20 mass % and mean particle diameter approximately 1.5 μm. Specifically, the slurry is fed to a polishing machine to subject the information recording surfaces of the workpiece to the first polishing.

In the polishing machine, polishing pads made of a urethane resin foam impregnated with cerium oxide are stuck to the surfaces of the polishing machine that contact the workpiece. The polishing machine is operated, thus simultaneously polishing the upper and lower information recording surfaces of the workpiece while applying a load of approximately 49N (5 kgf) to the workpiece via the polishing pads, until the workpiece reaches a predetermined thickness.

Polishing agent and slurry will become attached to the workpiece during the first polishing, and hence after the first polishing the workpiece is washed using water, a detergent or the like. During this washing, it is preferable to subject the workpiece to ultrasound of a suitable frequency. By subjecting the workpiece to ultrasound, the polishing agent and slurry can be removed from the surfaces of the workpiece more easily.

Precision Polishing Step (Step S7)

Next, the workpiece is subjected to precision polishing as second polishing.

Polishing pads are used, which each have a nap layer as the outermost surface layer thereof, and as the nap layer is used a polishing member, which is manufactured by fusing a resin having a 100% modulus, which is an index of the surface hardness, in a range of 7,840 to 24,500 kPa (80 to 250 kg/cm²), and then cutting off the outermost surface to expose voids in the resin to the outside. As a result of using such resin with the 100% modulus being in such a high range, the surface layer of the nap layer is hard microscopically and hence waviness components within a wavelength range of 0.1 to 5 mm on the information recording surfaces of the workpiece can be reduced during precision polishing.

When the 100% modulus is in a range of 7,840 to 24,500 kPa (80 to 250 kg/cm²), the surface layer of the nap layer is hard microscopically. For example, polyurethane resin is microscopically composed of an amorphous layer, and a crystalline layer which is harder than the amorphous layer, and hence the 100% modulus can be used as an index of the degree of crystallization.

For example, a nap layer formed of a resin having a large degree of crystallization, i.e., a resin having a high 100% modulus has a property that it is hard microscopically and soft macroscopically due to the presence of voids contained in the nap layer. The detailed mechanism that brings about such a property is not known, but it is considered that the microscopically high hardness of the nap layer is effective for eliminating waviness components of a wavelength range from 0.1 to 5 mm.

It is thus preferable for the value of the 100% modulus to be large, but if the value of the 100% modulus is too large, then it will become difficult to form the nap layer homogeneously. If the 100% modulus exceeds 24,500 kPa(250 kg/cm²), then not only will it become difficult to form the nap layer so as to be homogeneous and flat, but moreover fine scratches will become prone to occurring during the precision polishing.

It is particularly preferable for the 100% modulus to be in a range of 9,800 to 19,600 kPa(100 to 200 kg/cm²), since then waviness components of frequency 0.1 to 5 mm on the information recording surfaces of the workpiece can be further reduced. It is thought that the reason for this is that the hardness of the surface layer of the nap layer is sufficiently high, but also the homogeneity is high.

There are no particular limitations on the underlayer, the upper surface of which has the nap layer formed thereon; for example, this underlayer may be the base layer of a suede type polishing pad, or a plate of a polishing machine. In the latter case, the nap layer can be stuck directly onto the metal plate using an adhesive.

In the former case, a nonwoven cloth made of a urethane resin or the like, or a resin sheet made of vinyl chloride, PET or the like can be used as the base layer. The thickness of the nap layer is, for example, in a range of 0.2 to 1 mm, and the opening diameter is, for example, in a range of 30 to 100 μm, although there is no particular limitation to these thickness and opening diameter ranges.

The precision polishing is carried out with the rotational speed of the carrier rotating on its own axis that holds the workpiece in a range of 0.0333 to 0.25 per second (2 to 15 rpm). During the precision polishing, it is preferable for the spinning speed of the carrier to be 0.0333 per second (2 rpm) or more. If the rotational speed of the carrier is at least 0.0333 per second (2 rpm), then the time period for which the polishing pads precision-polish the workpiece in a given direction becomes relatively short, and hence waviness components of wavelength 10 to 50 μm become less prone to occurring. Moreover, if the rotational speed of the carrier exceeds 0.25 per second (15 rpm), then the burden on the polishing machine and/or the carrier becomes large, and hence the workpiece no longer rotates smoothly, and thus polishing unevenness, fine scratches and so on become prone to occurring on the surfaces of the workpiece.

A lanthanide oxide-containing slurry containing cerium oxide and/or lanthanum oxide, or a silica-containing slurry containing fine particulate silica is used as a polishing liquid. The lanthanide oxide-containing slurry may contain fluorine in a concentration of approximately 0.01 to 5%.

In the former case, the lanthanide oxide-containing slurry is preferably such that the maximum particle diameter of the slurry solids is not more than 3 μm. As a result, waviness components of wavelength 1 to 10 μm on the information recording surfaces of the workpiece can be substantially eliminated, and moreover the occurrence of polishing unevenness, fine scratches and so on can be prevented. Furthermore, the content in the polishing agent of particles having a particle diameter in a range of approximately 1 to 3 μm is preferably not more than 10% of the mass of the solids. As a result, the waviness components of wavelength 1 to 10 μm can be eliminated to an even greater extent.

There are no particular limitations on the mean particle diameter of the solids of the lanthanide oxide-containing slurry, but this mean particle diameter may be, for example, in a range of 0.1 to 1.6 μm. If the mean particle diameter of the polishing agent composed of the lanthanide oxide is too small, then the polishing efficiency of the slurry will drop, and polishing agent particles may agglomerate, resulting in polishing unevenness becoming prone to occur on the surfaces of the workpiece.

When polishing is carried out using the slurry containing fine particulate silica, commercially sold colloidal silica or commercially sold fumed silica may be used as the slurry. Such colloidal silica is comprised of a slurry in which silica having a mean particle diameter in a range of 0.03 to 0.5 μm has been dispersed in the form of a colloid. Silica does not agglomerate even if the mean particle diameter thereof is small as above, and hence local polishing unevenness is not prone to occurring; there are thus no particular limitations on the mean particle diameter of the silica.

In the workpiece subjected to the precision polishing, waviness components have been reduced to an extent that the workpiece can then be used as it is as a glass substrate product for information recording media. Therefore texture may be circumferentially formed on the outermost surface layer of the glass substrate so as to use the workpiece as a information medium for hard disks, without carrying out some of the other steps described below.

Next, simple washing is carried out on the polishing agent and slurry that has become loosely attached to the surfaces of the workpiece. For example, the workpiece is washed by switching over the slurry or colloid to water before stopping the operation of the polishing machine and thus rinsing or showering the workpiece, and/or the workpiece is taken out from the polishing machine and then washed in a bath of pure water while being subjected to ultrasound.

Next, in precision washing carried out after the simple washing, etching is carried out slightly on the surface layer of the workpiece to remove firmly attached polishing agent. An acidic aqueous solution containing hydrofluoric acid may be used as the etching liquid, although there is no particular limitation thereto. After the etching using the acidic aqueous solution, the workpiece is treated with a commercially sold alkaline aqueous solution, and is then rinsed by immersing in a bath of pure water to remove the alkaline aqueous solution from the workpiece; the workpiece is then rinsed by immersing in a bath of pure water, next the workpiece is immersed in a bath of isopropyl alcohol to replace water on the surfaces of the workpiece with IPA, and then the workpiece is dried in isopropyl alcohol vapor.

Chemical Strengthening Step (Step S8)

Next, the surface layer of the workpiece is subjected to chemical strengthening so as to improve the reliability of the workpiece, i.e. the strength and resistance of the workpiece to mechanical shock during handling, the influence of heat generated during formation of a film such as a magnetic film on the surface of the workpiece, deterioration through prolonged usage after being incorporated into a hard disk drive, and so on can be assuredly improved.

Specifically, potassium nitrate and sodium nitrate are first put into a chemical strengthening bath, and heating is carried out to a temperature of approximately 400° C., to melt them, thus forming a mixed molten salt. The workpiece is then immersed for several hours in the chemical strengthening bath. As a result, ion exchange takes place in which lithium ions and sodium ions contained in the glass are replaced by potassium ions contained in the mixed molten salt.

If aluminosilicate glass containing LiO₂ is used as the parent material glass, then a chemical strengthening layer having a depth of approximately 100 μm from the surface of the workpiece can be formed.

Next, the chemically strengthened workpiece is taken out from the chemical strengthening bath and then cooled slowly. After that, the workpiece is immersed for a prolonged period in a bath of pure water or a bath of warm water, to dissolve strengthening salt remaining on the surfaces of the workpiece into water to thereby remove the same from the workpiece.

Scrubbing Step (Step S9)

In this step, scrubbing is carried out on the workpiece after the precision polishing. The reason that it is after the precision polishing is that if scrubbing is carried out in a state in which a large amount of large pieces of foreign matter such as polishing agent is attached to the surfaces of the workpiece, then scratches will be prone to occurring due to this foreign matter being rubbed against the workpiece; it is thus preferable for the scrubbing to be carried out at a stage when the degree of cleanliness of the workpiece is high, i.e. immediately after the precision polishing.

It should be noted that in the case that chemical strengthening treatment is carried out after texturing, scrubbing is carried out after the chemical strengthening treatment. This is because after the chemical strengthening treatment the workpiece generally has foreign matter such as iron attached thereto, and abnormal projections due to the foreign matter and the like can be removed reliably by scrubbing. Furthermore, it is preferable to wash the workpiece using an acidic aqueous solution after the chemical strengthening but before the scrub washing, described below. As a result, the foreign matter and the like can be removed yet more completely.

Specifically, the scrubbing is carried out along the circumferential direction of the workpiece, using sponges in which parts that contact the workpiece have a shape consisting, for example, of lines or strips. Methods of carrying out the scrubbing include, for example, a method in which the workpiece is sandwiched between brush sponges in which the parts that contact the workpiece have a cylindrical shape, and the workpiece and the brush sponges are rotated, and a method in which the workpiece is sandwiched between sponges in which the parts that contact the workpiece have a tape-like shape, and the workpiece and the sponges are rotated. The apparatus for carrying out the scrubbing may be a commercially sold scrub washing apparatus.

After the scrubbing, the workpiece is subjected to scrub washing. As the washing liquid used in the scrub washing, for example pure water, electrolytic ion water, ozone water, hydrogenated water, an acidic aqueous solution, or an alkaline aqueous solution, or one of the above with a chelating agent, a surfactant, and/or a salt added thereto, can be used. Of these washing liquids, the alkaline aqueous solution is preferable. As a result of using an alkaline aqueous solution, an electrostatic repulsive force acts between foreign matter and the workpiece, and hence the scrub washing can be carried out while preventing foreign matter from reattaching to the workpiece.

During the scrub washing, ultrasound is applied to the workpiece in the washing liquid. As a result, damage to the workpiece, changes in the shape of the texture, and so on can be prevented from occurring. There are no particular limitations on the conditions of the scrub washing such as the frequency, power output, and time period of application of the ultrasound, and the temperature of the washing liquid, but as an example, the frequency of the ultrasound is not less than 38 kHz, the power output is not more than 1W/cm², and the time period of application is in a range of 1 to 20 min, and the temperature of the washing liquid is not more than 70° C.

After the scrub washing, the workpiece is rinsed using pure water and then dried. There are no particular limitations on the method of rinsing using pure water, and the method of carrying out the rinsing using pure water may be, for example, a method in which the workpiece is immersed in a bath of pure water (in this method, ultrasound may be applied), or a method in which pure water is showered or jetted onto the workpiece. Moreover, methods of drying the workpiece may include, for example, spin drying and isopropyl alcohol drying, that is, any rinsing and drying methods may be used so long as they are methods in accordance with the scrub washing as precision washing.

A predetermined examination is then carried out, and if the workpiece passes the examination, the workpiece is outputted as a glass substrate for information recording media.

Film Deposition Step (Step S10)

To manufacture a hard disk medium from the glass substrate for information recording media, film deposition is carried out in which at least a ground layer, a magnetic layer (i.e. a recording layer), and a protective film are formed in this order on the glass substrate. Moreover, texturing is carried out in which circumferential texture is formed on the magnetic layer. For example, if the glass substrate has not been formed thereon with circumferential texture, circumferentially texturing may be carried out on the magnetic layer of the glass substrate. Furthermore, in the film deposition, a seed layer may also be formed between the glass substrate for hard disks and the ground layer, and to make the hard disk medium have a multi-layer structure, buffer layers and shield layers may also be formed between the various layers.

Moreover, burnishing may also be carried out on the glass substrate after the film deposition using a tape or the like. As a result, soiling, i.e. foreign matter, attached to the protective film can be removed.

There are no particular limitations on the material, film thickness or film deposition method for each of the layers, but for example, in the case that a glass substrate is used, it is preferable to use an NiAl alloy as the seed layer, Cr or a Cr-based alloy as the ground layer, and a Co-based alloy as the magnetic layer. As a result, excellent information recording/playback characteristics of the produced hard disk medium can be secured. It is generally preferable for the film deposition method to be a sputtering method. As a result, a hard disk medium can be manufactured with the surface flatness kept the same as that of the glass substrate from which the hard disk medium is manufactured.

Examination Step (Step S11)

The shape of a predetermined region of an information recording surface of the hard disk medium is measured using an optical interferometer or an atomic force microscope (AFM), and to carry out line analysis on an area of the information recording surface of the hard disk medium along the flying direction of the magnetic head or the circumferential direction of the hard disk medium.

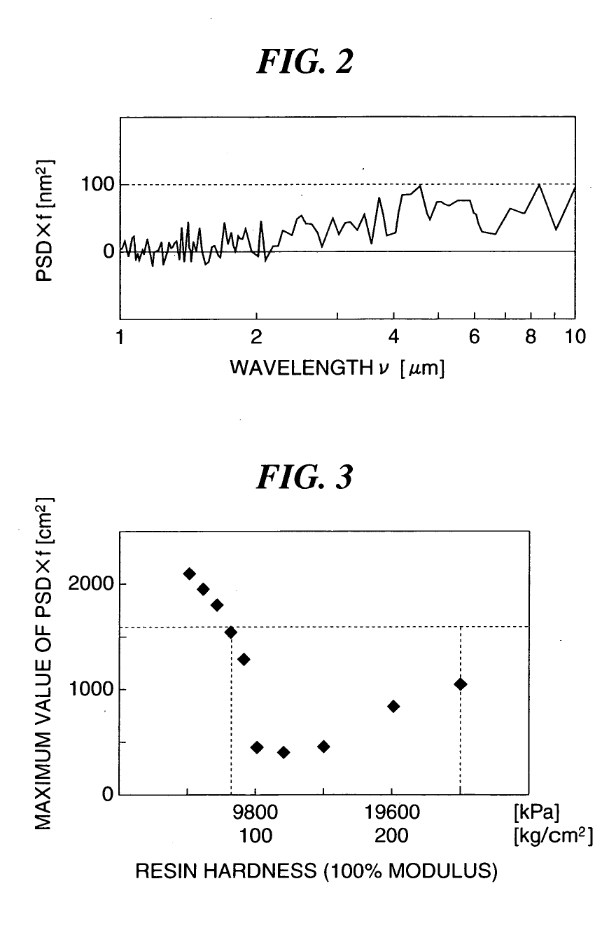

In the line analysis, the PSD corresponding to the predetermined wavelength ν is calculated (see FIG. 11). The product PSD×f of the PSD and the frequency f, which is the reciprocal of the predetermined wavelength ν, is then calculated (see FIG. 2). As a result, the baseline of the PSD function can be made to be horizontal, and hence it becomes easy to compare PSD values corresponding to a predetermined wavelength ν range. Moreover, it is preferable to carry out the line analysis on a plurality of lines, and average the results. As a result, the line analysis can be carried out more accurately.

Referring to FIG. 2, the maximum value of PSD×f corresponding to a predetermined wavelength ν range of, for example, 1 to 10 μm, is not more than approximately 100 nm². A good correlation has been obtained between this value and the value of the TOH as measured by piezo signal detection as described later. It should be noted that the TOH is not more than 4.5 nm if the maximum value of PSD×f is approximately 100 nm².

That is, the TOH value can be estimated merely by calculating PSD×f, and without actually measuring the TOH using a piezo element. Note that the measurement using the piezo element is carried out with the piezo element in contact with the surface of the medium.

In contrast, a measurement using an optical interferometer or an atomic force microscope (AFM: non-contact mode) is a preferable method because nothing needs to be disposed in contact with the surface of the medium.

Hard disk media having a TOH of not more than 4.5 nm, for example, have good information recording/playback characteristics. Moreover, in the hard disk media, waviness which hinder the magnetic head from stably flying has been reduced, and therefore wobbling of the magnetic head during flight is insignificant and head crashes are not prone to occurring. Also, in the hard disk media, thermal asperity is not prone to occurring (hereinafter, these characteristics will be collectively referred to as “good medium characteristics.”).

Hard disk media, which have been confirmed as having a maximum value of not more than a certain predetermined value on the surface thereof, are delivered as final products. Then, the present manufacturing process is completed. Note that details of the predetermined region and the predetermined value mentioned above will be given later.

Hard disk medium having the maximum value of PSD×f on the surface of not more than the predetermined value are attached to a spindle of the HDD, and a magnetic head and others are mounted to complete a hard disk drive.

In the above examination step S11, it was checked whether or not the maximum value of PSD×f on the surface thereof is not more than the predetermined value. However, such an examination may also be carried out on the manufactured glass substrate for information recording media after the scrubbing of step S9. That is, this glass substrate may be subjected to checking as to whether or not the maximum value of PSD×f on the surface of the substrate is not more than the predetermined value.

If, in the glass substrate for information recording media or the hard disk medium, the maximum value of PSD×f on the surface thereof is not more than approximately 100 nm², then it will be easily turned out through checking that the TOH on the surface thereof is not more than 4.5 nm. As a result, it is still possible to obtain an information recording apparatus such as a hard disk drive manufactured using the glass substrate or medium, having a low TOH; this is because the shape of the surface of the glass substrate or medium is maintained as it is on the information recording apparatus.

According to the present embodiment, the surface shape of an information recording medium in a predetermined region of the surface is measured along the circumferential direction of the medium using the probe of an AFM or an optical interferometer, the product PSD×f of the PSD corresponding to a predetermined wavelength ν and the frequency f, which is the reciprocal of the wavelength ν, is calculated, and the maximum value is controlled to not more than a predetermined value. As a result, waviness components which hinder the head from stably flying can be eliminated; for example, the TOH can be made to be not more than 4.5 nm. Moreover, it can be easily confirmed whether or not the maximum value of PSD×f is not more than the predetermined value.

A detailed description will now be given of a first example of the examination step S11 in FIG. 1. In the present example, circumferential texture is formed on a medium for hard disks.

In the examination step S1, the surface shape in the vicinity of the circumferential texture in a region of area 0.1 mm to 5 mm square of an information recording surface of the manufactured hard disk medium is measured over a predetermined wavelength ν range of 0.1 to 5 mm along the circumferential direction of the hard disk using an optical interferometer (“ZygoNewview” made by Zygo Corporation), and line analysis is carried out.

The reason that the area of the predetermined region is made to be 0.1 mm to 5 mm square is that, when a 2.5× objective lens is used, the area of the visual field of the optical-interferometer is 2406 μm×1796 μm when a 0.5× zoom function is used, and 43901 μm×33101 m when a 1.0× zoom function is used.

In the line analysis, the PSD corresponding to the predetermined wavelength ν as shown in FIG. 11 is calculated, and the product PSD×f of the calculated PSD and the frequency f, which is the reciprocal of the corresponding predetermined wavelength ν, is calculated (see FIG. 2). Then, it is checked whether or not the maximum value of PSD×f is not more than 1600 cm², and a medium having such a maximum value of PSD×f is delivered as a final product.

The reason for this is that if the maximum value of PSD×f on the surface of a hard disk medium is controlled to not more than 1600 cm², then the TOH for that hard disk medium will inevitably be not more than 4.5 nm, and hence the hard disk medium will have good medium characteristics. Preferably, the maximum value of PSD×f is controlled to not more than 1300 cm², and then the TOH for the hard disk medium can be made to be not more than 4.0 nm.

A detailed description will now be given of a second example of the examination step S11 in FIG. 1.

In the examination step S11, the surface shape in the vicinity of the circumferential texture in a region of area 10 μm to 200 μm square of an information recording surface of the hard disk medium is measured over a predetermined wavelength ν range of 10 to 200 μm along the circumferential direction of the hard disk using an optical interferometer, and line analysis is carried out.

The reason that the area of the predetermined region is made to be 10 μm to 200 μm square is that the area of the visual-field of the optical interferometer is 62 μm×421 μm when a 50× objective lens and a 2× zoom function are used.

In the line analysis, the PSD corresponding to the predetermined wavelength ν as shown in FIG. 11 is calculated, and the product PSD×f of the PSD and the frequency f, which is the reciprocal of the corresponding predetermined wavelength ν, is calculated (see FIG. 2).

It is checked whether or not the maximum value of PSD×f on the surface of the medium is not more than 1100 cm², and a medium having such a maximum value of PSD×f is delivered as a final product.

The reason for this is that if the maximum value of PSD×f on the surface of a hard disk medium is controlled to not more than 1100 cm², then the TOH for that hard disk will inevitably be not more than 4.5 nm, and hence the hard disk medium will have good medium characteristics. Preferably, the maximum value of PSD×f is controlled to not more than 900 cm², and then the TOH for the hard disk medium can be made to be not more than 4.0 nm.

A detailed description will now be given of a third example of the examination step S11 in FIG. 1.

In the examination step S1, the surface shape in the vicinity of the circumferential texture in a region of area 1 μm to 50 μm square of an information recording surface of the hard disk medium is measured over a wavelength ν range of 1 to 50 μm using an AFM (“Nanoscope IV” scanning probe microscope made by Veeco Inc. (formerly, Digital Instruments), and line analysis is carried out along the circumferential direction of the hard disk medium.

The reason that the area of the predetermined region is made to be 1 μm to 50 μm square is that the visual field area of the AFM is 50 μm×50 μm.

In the line analysis, the PSD corresponding to the predetermined wavelength ν as shown in FIG. 11 is calculated, and the product PSD×f of the PSD and the frequency f, which is the reciprocal of the corresponding predetermined wavelength ν, is calculated (see FIG. 2). It is checked whether or not the maximum value of PSD×f on the surface of the medium is not more than 100 nm², and outputted as final products.

The reason for this is that if the maximum value of PSD×f on the surface of a hard disk medium is controlled to not more than 100 nm², then the TOH for that hard disk will inevitably be not more than 4.5 nm, and hence the hard disk will have good medium characteristics. Preferably, the maximum value of PSD×f is controlled to not more than 80 nm², and then the TOH for the hard disk medium can be made to be not more than 4.0 nm.

According to the first to third examples of the examination step described above, the surface shape of the circumferential texture in a region of a predetermined area of an information recording surface of the hard disk medium is measured using an optical interferometer or an AFM, and it can be easily confirmed whether or not the maximum value of PSD×f is not more than a certain predetermined value; the presence of waviness components which hinder a magnetic head from stably flying can thus easily be examined, and hence the TOH can be made low.

In the line analysis in the first to third examples of the examination step described above, it is preferable to extract the PS (power spectrum) for a plurality of lines along the circumferential texture, and average the extraction results. As a result, the line analysis can be carried out more accurately. With an AFM, for example the PS can be extracted for up to 1024 lines. With an optical interferometer, for example the line analysis can be carried out on a three-dimensional image.

In the first to third examples of the examination step described above, the line analysis is carried out along the circumferential direction, but the line analysis may also be carried out along the radial direction. In this case, it is preferable to consider the both results obtained by line analysis carried out along both the circumferential direction and the radial direction.

For example, if measures are taken such that the line analysis result obtained by carrying out line analysis along the circumferential direction is kept down to a low value, and the line analysis result obtained by carrying out line analysis along the radial direction is a high value, then the surface shape of the information recording medium along the direction perpendicular to the head flying direction will be suitably rough, and hence it will possible to reduce the resistance that acts on the magnetic head, which flies while wobbling.

However, it is thought that if the result obtained by carrying out line analysis along the radial direction is too high a value, then the surface shape of the hard disk will become prone to being abraded by the flying magnetic head. It is thus most preferable for the result for the radial direction to be a high value such that the time taken until a head crash occurs is lengthened.

Moreover, in the first to third examples of the examination step described above, the product PSD×f of the PSD and the frequency f, which is the reciprocal of the corresponding predetermined wavelength ν, is calculated and hence the baseline can be made to be horizontal, but in the case of two-dimensional measurement, the product PSD×f² may be calculated.

The examination step according to the first to third examples is carried out after the various steps that are carried out before step S11 in the present manufacturing method, but the examination step may also be carried out before the film deposition of step S10.

In the above, the hard disk medium is described as a main example, but the information recording medium is not limited this, and the present invention may be applied to an optical magnetic disk, an optical disk, or the like.

### EXAMPLES

A description will now be given of examples of the present invention.

The present inventors et al. carried out the steps described below in the order given in accordance with the method of manufacturing an information recording medium shown in FIG. 1, thus preparing Test Pieces 1 to 19 and Comparative Test Pieces 1 to 11, i.e. information recording media.

Parent Material Glass Selection Step (Step S1)

An aluminosilicate glass having a composition of 66.0 mol % SiO₂, 11.0 mol % Al₂O₃, 8.0 mol % Li₂O, 9.0 mol % Na₂O, 2.4 mol % MgO, 3.6 mol % CaO, 0.2 mol % K₂O, and 2.0 mol % SrO was selected as a parent material glass.

Glass Sheet Production Step (Step S2)

A glass sheet of uniform thickness was produced from the selected parent material glass using a float process.

Workpiece Cuttina-Out Step (Step S3)

The glass sheet was simultaneously cut along the inner and outer peripheries thereof using hard metal cutters, thus cutting out a donut-shaped workpiece having an inside diameter of 24 mm and an outside diameter of 96 mm with good concentricity between the inner and outer peripheries.

Edge Surface Polishing Step (Step S4)

Next, the inner and outer peripheral edge surfaces of the workpiece were subjected to two stages of grinding using grindstones having attached thereto #325 diamond abrasive grains in the first stage and then #500 diamond abrasive grains in the second stage, thus precisely adjusting the inside and outside diameters of the workpiece to the required product dimensions. At the same time as this grinding, the inner and outer peripheral edge surfaces were subjected to chamfering using grindstones, thus obtaining predetermined product dimensions. Next, after carrying out the grinding and chamfering, the inner and outer peripheral edge surfaces were subjected to polishing using a slurry containing cerium oxide, thus making the inner and outer peripheral edge surfaces smoother.

Lapping Step (Step S5)

The upper and lower information recording surfaces of the workpiece were simultaneously subjected to two stages of lapping using a polishing machine, while feeding in, between the metal plates of the polishing machine and the information recording surfaces of the workpiece, a slurry containing 0.1 to 65 mass % of #600 alumina abrasive grains in the first stage and then #1000 alumina abrasive grains in the second stage. The workpiece was then washed using water or a detergent while subjecting the workpiece to ultrasound of frequency approximately 48 kHz and power output 1W/cm².

First Polishing Step (Step S6)

Next, the information recording surfaces of the workpiece were subjected to first polishing using a polishing machine while feeding in a lanthanide oxide-containing slurry containing cerium oxide and lanthanum oxide of solids concentration approximately 20 mass % and mean particle diameter in a range of 0.05 to 1.6 μm. The polishing machine used was one having polishing pads made of a urethane resin foam impregnated with cerium oxide stuck to the surfaces of the polishing machine that contact the workpiece. The polishing machine was operated, thus simultaneously polishing the upper and lower information recording surfaces of the workpiece while applying a load of approximately 49N(5 kgf) to the workpiece via the polishing pads, until the workpiece reached a predetermined thickness.

The workpiece was then washed using water or a detergent while subjecting the workpiece to ultrasound of frequency approximately 48 kHz and power output 1W/cm².

Precision Polishing Step (Step S7)

The upper and lower surfaces of the workpiece were simultaneously subjected to precision polishing, adjusting the rotational speed of the upper and lower metal plates of the polishing machine such that the rotational speed of the carrier was in a range of approximately 0.166 to 0.2833 per second (1 to 20 rpm).

In the precision polishing, suede type polishing pads were used. The nap layer of each of the polishing pads was a polishing member manufactured by melting a resin having a 100% modulus in a range of 4,900 to 24,500 kPa (50 to 250 kg/cm²) to cause the resin to foam, and shaving off the outmost surface layer to expose voids therein to the outside; the thickness of the nap layer was in a range of 0.2 to 1 mm, and the opening diameter was in a range of 30 to 100 μm. The base layer in the suede type polishing pad is comprised of a resin sheet. A lanthanide oxide-containing slurry having cerium oxide and lanthanum oxide as principal components thereof, or a slurry containing silica in a state of a colloid was used. The both slurries each had a maximum particle diameter of approximately 1 to 5 μm, a mean particle diameter of 0.05 to 1.6 μm, and a particle diameter range of 1 to 5 μm, and a polishing agent content of approximately 0.1 to 65 mass % relative to the total solids mass of the polishing agent.

Moreover, before stopping the operation of the polishing machine, the slurry was switched over to water, thus rinsing the workpiece, then the workpiece was washed in a bath of pure water while subjecting the workpiece to ultrasound of frequency approximately 48 kHz and power output 1W/cm², and then the workpiece was subjected to showering using pure water. After that, etching was carried out by immersing the workpiece for 1 minute in a bath of a buffered hydrofluoric acid aqueous solution, specifically an aqueous solution of 0.01 mass % of hydrofluoric acid and 0.2 mass % of ammonium fluoride, maintained at 40° C., while subjecting the workpiece to ultrasound of frequency approximately 48 kHz and power output 1W/cm².

The workpiece was then immersed for 1 minute in a bath of a commercially sold alkaline aqueous solution of pH11 (“RBS25” made by Chemical-Products Corporation) maintained at 40° C., while subjecting the workpiece to ultrasound of frequency approximately 48 kHz and power output 1W/cm². After that, the workpiece was pulled out from the bath of the alkaline aqueous solution, and was rinsed by immersing in a bath of pure water, and then finally the workpiece was rinsed in a bath of pure water, the workpiece was immersed in a bath of isopropyl alcohol for 2 minutes while subjecting the workpiece to ultrasound of frequency approximately 48 kHz, and then the workpiece was dried for 1 minute in isopropyl alcohol vapor.

Chemical Strengthening Step (Step S8)

First, the workpiece was immersed for 3 hours in a bath containing a mixed molten salt of reagent grade 1 potassium nitrate and reagent grade 1 sodium nitrate in a ratio of 4:6 maintained at 380° C., thus carrying out chemical strengthening on a surface layer of the workpiece through ion exchange, and then the workpiece was cooled slowly, before being immersed for a prolonged period in a bath of pure water.

Scrubbing Step (Step S9)

A polycarbonate type polyurethane resin cut into strips was stuck in a spiral fashion onto cylindrical rollers using double-sided tape, thus preparing urethane sponges for scrubbing. In the urethane sponges, the urethane resin was stuck on such that that shape of the surface layer thereof at the parts contacting the workpiece consisted of strips. The workpiece was rotated while being held by an inner peripheral edge part of a commercially sold scrub washing apparatus, and the rotating workpiece was sandwiched between two urethane sponges, whereby the surfaces of the workpiece were subjected to scrubbing in the circumferential direction of the workpiece for 10 seconds. At this time, the rotational speed of the workpiece was made to be 5 per second (300 rpm), and the pushing pressure of the sponges was made to be 39,200 Pa (400 g/cm²), and moreover a potassium hydroxide aqueous solution of pH11 was fed in between the workpiece and the urethane sponges at a rate of 30 ml/min.

The workpiece was next immersed in a bath of an alkaline aqueous solution of pH11 held at 40° C. for approximately 1 minute while subjecting the workpiece to ultrasound of frequency approximately 48 kHz and power output 1W/cm². The workpiece was then pulled out from the alkaline aqueous solution bath and rinsed in a bath of pure water, thus removing the alkaline aqueous solution. Finally, the workpiece was rinsed in a bath of pure water, immersed for 2 minutes in a bath of isopropyl alcohol while being subjected to ultrasound of frequency 48 kHz, and then dried in isopropyl alcohol vapor for 1 minute, thus completing the drying.

Film Deposition Step (Step S10)

Film deposition was carried out in which a seed layer made of an NiAl alloy, a ground layer made of a CrMo alloy, a magnetic layer made of a CoCrPt alloy, and a carbon-based protective film were formed in this order on the glass substrate for an information recording medium using a sputtering method. Texturing was circumferentially carried out on the magnetic layer. After the film deposition, the glass substrate was coated with a perfluoropolyether type lubricant on the surface using an immersion method, and further subjected to tape burnishing of the surface thereof. A hard disk medium was thus manufactured.

Examination Step (Step S1)

The surface shape in a predetermined region on an information recording surface of the manufactured information recording medium was line-analyzed along the circumferential direction of the information recording medium using the probe of a Nanoscope IV or a ZygoNewview. In the line analysis, the product PSD×f of the PSD corresponding to the predetermined wavelength ν and the frequency f was calculated (see FIG. 2).

In the line analysis, the line analysis results obtained by carrying out the line analysis over a plurality of lines were averaged, and the presence of waviness components which hinder a magnetic head from stably flying was estimated based on the maximum value of the calculated product PSD×f. As a result of the estimation, it was confirmed that the maximum value of PSD×f for the information recording medium was not more than a certain predetermined value. Information recording media having a TOH of not more than 4.5 nm, more preferably not more than 4.0 nm, were obtained. Details of the predetermined region and the predetermined value mentioned above will be given later in Examples 2 to 4.

A description will now be given of Test Pieces 1 to 19 and Comparative Test Pieces 1 to 11 of information recording media according to first examples.

In the examination step S11 in FIG. 1, the TOH (nm), the presence/absence of fine scratches, the presence/absence of polishing unevenness, and the waviness component size (nm) were measured for each of the prepared Test Pieces 1 to 19 and Comparative Test Pieces 1 to 11, and a study was carried out into the relationship between the resin hardness expressed by the 100% modulus (kPa (kg/cm²)) and the value of PSD×f (cm²) (Test Pieces 1 to 7, Comparative Test Pieces 1 to 3), the relationship between the rotational speed of the carrier (revolutions per second (rpm)) and the maximum value of PSD×f (cm²) (Test Pieces 8 to 12, Comparative Test Pieces 4 to 6), the relationship-between the maximum particle diameter of the polishing agent (μm) and the maximum value of PSD×f (nm²) (Test Pieces 13 to 19, Comparative Test Pieces 7 to 11), and so on.

To calculate the TOH, the flying height of the head was reduced by gradually reducing the rotational speed of the information recording medium, and the TOH was calculated from the rotational speed when the output of a piezo signal detected by a piezo signal detector installed on the magnetic head rose suddenly.

The measurement results are shown below in Table 1.

TABLE 1

| | | | | | | Slurry Solids | | | | | | |
|---|---|---|---|---|---|---|---|---|---|---|---|---|
| | | | | | | | | | Proportion | | | |
| | | | | | | | | | of Polishing | | | |
| | | | | | | | | | Agent Having | | | |
| | | | | | | | | | Particle | | | |
| | | | | Rotational Speed | | | Mean | Maximum | Diameter of | | | |
| | | | | of Carrier | | | Particle | Particle | at least 1 μm | | | |
| | | Resin Hardness | | [revolutions | | Principal | Diameter | Diameter | of Slurry Solids | Fine | Polishing | TOH |
| | | [kPa] | [kg/cm²] | per second] | [rpm] | Component | [μm] | [μm] | [mass %] | Scratches | Unevenness | [nm] |
| Test | 1 | 7840 | 80 | 0.1 | 6 | CERIUM OXIDE | 1 | 2 | 3 | NO | NO | 4.4 |
| Piece | 2 | 8820 | 90 | 0.1 | 6 | CERIUM OXIDE | 1 | 2 | 3 | NO | NO | 4.0 |
| | 3 | 9800 | 100 | 0.1 | 6 | CERIUM OXIDE | 1 | 2 | 3 | NO | NO | 3.3 |
| | 4 | 11760 | 120 | 0.1 | 6 | CERIUM OXIDE | 1 | 2 | 3 | NO | NO | 3.2 |
| | 5 | 14700 | 150 | 0.1 | 6 | CERIUM OXIDE | 1 | 2 | 3 | NO | NO | 3.4 |
| | 6 | 19600 | 200 | 0.1 | 6 | CERIUM OXIDE | 1 | 2 | 3 | NO | NO | 3.5 |
| | 7 | 24500 | 250 | 0.1 | 6 | CERIUM OXIDE | 1 | 2 | 3 | NO | NO | 4.0 |
| | 8 | 12740 | 130 | 0.0333 | 2 | CERIUM OXIDE | 1 | 2 | 3 | NO | NO | 4.4 |
| | 9 | 12740 | 130 | 0.05 | 3 | CERIUM OXIDE | 1 | 2 | 3 | NO | NO | 4.0 |
| | 10 | 12740 | 130 | 0.0666 | 4 | CERIUM OXIDE | 1 | 2 | 3 | NO | NO | 3.8 |
| | 11 | 12740 | 130 | 0.15 | 9 | CERIUM OXIDE | 1 | 2 | 3 | NO | NO | 3.6 |
| | 12 | 12740 | 130 | 0.25 | 15 | CERIUM OXIDE | 1 | 2 | 3 | NO | NO | 3.5 |
| | 13 | 11760 | 120 | 0.1 | 6 | CERIUM OXIDE | 0.1 | 1.1 | 0.1 | NO | NO | 3.4 |
| | 14 | 11760 | 120 | 0.1 | 6 | CERIUM OXIDE | 1 | 1.9 | 3 | NO | NO | 3.5 |
| | 15 | 11760 | 120 | 0.1 | 6 | CERIUM OXIDE | 0.5 | 1.5 | 9 | NO | NO | 3.8 |
| | 16 | 19600 | 200 | 0.25 | 15 | CERIUM OXIDE | 0.1 | 1.1 | 0.1 | NO | NO | 3.6 |
| | 17 | 19600 | 200 | 0.25 | 15 | SILICA | 0.03 | 0.1 | 0 | NO | NO | 3.3 |
| | 18 | 19600 | 200 | 0.25 | 15 | SILICA | 0.1 | 0.15 | 0 | NO | NO | 3.3 |
| | 19 | 12740 | 130 | 0.2 | 12 | CERIUM OXIDE | 0.5 | 2.5 | 18 | NO | NO | 3.8 |
| Com- | 1 | 4900 | 50 | 0.05 | 3 | CERIUM OXIDE | 1 | 2 | 3 | NO | NO | 6.2 |
| parative | 2 | 5880 | 60 | 0.05 | 3 | CERIUM OXIDE | 1 | 2 | 3 | NO | NO | 5.9 |
| Test | 3 | 6860 | 70 | 0.05 | 3 | CERIUM OXIDE | 1 | 2 | 3 | NO | NO | 5.1 |
| Piece | 4 | 7840 | 80 | 0.0166 | 1 | CERIUM OXIDE | 1 | 2 | 3 | YES | NO | 5.5 |
| | 5 | 7840 | 80 | 0.2833 | 17 | CERIUM OXIDE | 1 | 2 | 3 | YES | NO | 5.0 |
| | 6 | 7840 | 80 | 0.333 | 20 | CERIUM OXIDE | 1 | 2 | 3 | NO | YES | 5.1 |
| | 7 | 7840 | 80 | 0.0333 | 2 | CERIUM OXIDE | 0.05 | 1 | 0.1 | NO | NO | 5.5 |
| | 8 | 7840 | 80 | 0.15 | 9 | CERIUM OXIDE | 1.5 | 5 | 65 | NO | YES | 5.7 |
| | 9 | 11760 | 120 | 0.1 | 6 | CERIUM OXIDE | 1.6 | 3.3 | 40 | NO | NO | 4.9 |
| | 10 | 11760 | 120 | 0.1 | 6 | CERIUM OXIDE | 0.5 | 3.2 | 22 | YES | NO | 4.8 |
| | 11 | 7840 | 80 | 0.0666 | 4 | CERIUM OXIDE | 0.5 | 3.1 | 18 | NO | NO | 5.3 |

Test Piece 1

In the precision polishing step, a polishing member made of a resin having a 100% modulus of 7,840 kPa (80 kg/cm²), a polishing machine having a carrier rotational speed of 0.1 per second (6 rpm), and a slurry solids having as a principal component thereof cerium oxide having a mean particle diameter of lam, a maximum particle diameter of 2 μn, and a content of particles having a particle diameter of at least 1 μm of 3 mass % of the slurry solids were used. For an information recording medium of Test Piece 1 manufactured using such a precision polishing step, there were no fine scratches, there was no polishing unevenness, and the TOH was 4.4 nm.

Test Piece 2

In the precision polishing step, the same polishing machine and slurry solids as in Test Piece 1 were used, but a polishing member made of a resin having a 100% modulus of 8,820 kPa (90 kg/cm²) was used. For an information recording medium of Test Piece 2 manufactured using such a precision polishing step, there were no fine scratches, there was no polishing unevenness, and the TOH was 4.0 nm.

Test Piece 3

In the precision polishing step, the same polishing machine and slurry solids as in Test Piece 1 were used, but a resin having a 100% modulus of 9,800 kPa (100 kg/cm²) was used. For an information recording medium of Test Piece 3 manufactured using such a precision polishing step, there were no fine scratches, there was no polishing unevenness, and the TOH was 3.3 nm.

Test Piece 4

In the precision polishing step, the same polishing machine and slurry solids as in Test Piece 1 were used, but a resin having a 100% modulus of 11,760 kPa (120 kg/cm²) was used. For an information recording medium of Test Piece 4 manufactured using such a precision polishing step, there were no fine scratches, there was no polishing unevenness, and the TOH was 3.2 nm.

Test Piece 5

In the precision polishing step, the same polishing machine and slurry solids as in Test Piece 1 were used, but a polishing member made of a resin having a 100% modulus of 14,700 kPa (150 kg/cm²) was used. For an information recording medium of Test Piece 5 manufactured using such a precision polishing step, there were no fine scratches, there was no polishing unevenness, and the TOH was 3.4 nm.

Test Piece 6

In the precision polishing step, the same polishing machine and slurry solids as in Test Piece 1 were used, but a polishing member made of a resin having a 100% modulus of 19,600 kPa (200 kg/cm²) was used. For an information recording medium of Test Piece 6 manufactured using such a precision polishing step, there were no fine scratches, there was no polishing unevenness, and the TOH was 3.5 nm.

Test Piece 7

In the precision polishing step, the same polishing machine and slurry solids as in Test Piece 1 were used, but a polishing member made of a resin having a 100% modulus of 24,500 kPa (250 kg/cm²) was used. For an information recording medium of Test Piece 7 manufactured using such a precision polishing step, there were no fine scratches, there was no polishing unevenness, and the TOH was 4.0 nm.

Test Piece 8

In the precision polishing step, a polishing member made of a resin having a 100% modulus of 12,740 kPa (130 kg/cm²), a polishing machine having a carrier rotational speed of 0.0333 per second (2 rpm), and slurry solids having as a principal component thereof cerium oxide having a mean particle diameter of 1 μm, a maximum particle diameter of 2 μm, and a content of particles having a particle diameter of at least 1 μm of 3 mass % of the slurry solids were used. For an information recording medium of Test Piece 8 manufactured using such a precision polishing step, there were no fine scratches, there was no polishing unevenness, and the TOH was 4.4 nm.

Test Piece 9

In the precision polishing step, the same polishing member made of the resin and slurry solids as in Test Piece 8 were used, but a polishing machine having a carrier rotational speed of 0.05 per second (3 rpm) was used. For an information recording medium of Test Piece 9 manufactured using such a precision polishing step, there were no fine scratches, there was no polishing unevenness, and the TOH was 4.0 nm.

Test Piece 10

In the precision polishing step, the same polishing member made of the resin and slurry solids as in Test Piece 8 were used, but a polishing machine having a carrier rotational speed of 0.0666 per second (4 rpm) was used. For an information recording medium of Test Piece 10 manufactured using such a precision polishing step, there were no fine scratches, there was no polishing unevenness, and the TOH was 3.8 nm.

Test Piece 11

In the precision polishing step, the same polishing member made of the resin and slurry solids as in Test Piece 8 were used, but a polishing machine having a carrier rotational speed of 0.15 per second (9 rpm) was used. For an information recording medium of Test Piece 11 manufactured using such a precision polishing step, there were no fine scratches, there was no polishing unevenness, and the TOH was 3.6 nm.

Test Piece 12

In the precision polishing step, the same polishing member made of the resin and slurry solids as in Test Piece 8 were used, but a polishing machine having a carrier rotational speed of 0.25 per second (15 rpm) was used. For an information recording medium of Test Piece 12 manufactured using such a precision polishing step, there were no fine scratches, there was no polishing unevenness, and the TOH was 3.5 nm.

Test Piece 13

In the precision polishing step, a polishing member made of a resin having a 100% modulus of 11,760 kPa (120 kg/cm²), a polishing machine having a carrier rotational speed of 0.1 per second (6 rpm), and slurry solids having as a principal component thereof cerium oxide having a mean particle diameter of 0.1 μm, a maximum particle diameter of 1.1 μm, and a content of particles having a particle diameter of at least 1 μm of 0.1 mass % of the slurry solids were used. For an information recording medium of Test Piece 13 manufactured using such a precision polishing step, there were no fine scratches, there was no polishing unevenness, and the TOH was 3.4 nm.

Test Piece 14

In the precision polishing step, the same polishing member made of the resin and polishing machine as in Test Piece 13 were used, but slurry solids having as a principal component thereof cerium oxide having a mean particle diameter of 1 μm, a maximum particle diameter of 1.9 μm, and a content of particles having a particle diameter of at least 1 μm of 3 mass % of the slurry solids was used. For an information recording medium of Test Piece 14 manufactured using such a precision polishing step, there were no fine scratches, there was no polishing unevenness, and the TOH was 3.5 nm.

Test Piece 15

In the precision polishing step, the same polishing member made of the resin and polishing machine as in Test Piece 13 were used, but slurry solids having as a principal component thereof cerium oxide having a mean particle diameter of 0.5 μm, a maximum particle diameter of 1.5 μm, and a content of particles having a particle diameter of at least 1 μm of 9 mass % of the slurry solids was used. For an information recording medium of Test Piece 15 manufactured using such a precision polishing step, there were no fine scratches, there was no polishing unevenness, and the TOH was 3.8 nm.

Test Piece 16

In the precision polishing step, a polishing member made of a resin having a 100% modulus of 19,600 kPa (200 kg/cm²), a polishing machine having a carrier rotational speed of 0.25 per second (15 rpm), and slurry solids having as a principal component thereof cerium oxide having a mean particle diameter of 0.1 μm, a maximum particle diameter of 1.1 μm, and a content of particles having a particle diameter of at least 1 μm of 0.1 mass % of the slurry solids were used. For an information recording medium of Test Piece 16 manufactured using such a precision polishing step, there were no fine scratches, there was no polishing unevenness, and the TOH was 3.6 nm.

Test Piece 17

In the precision polishing step, the same polishing member made of the resin and polishing machine as in Test Piece 16 were used, but slurry-solids having as a principal component thereof silica having a mean particle diameter of 0.03 μm, a maximum particle diameter of 0.1 μm, and containing no particles having a particle diameter of at least 1 μm was used. For an information recording medium of Test Piece 17 manufactured using such a precision polishing step, there were no fine scratches, there was no polishing unevenness, and the TOH was 3.3 nm.

Test Piece 18

In the precision polishing step, the same polishing member made of the resin and polishing machine as in Test Piece 16 were used, but slurry solids having as a principal component thereof a colloid containing silica having a mean particle diameter of 0.1 μm, a maximum particle diameter of 0.15 μm, and containing no particles having a particle diameter of at least 1 μm was used. For an information recording medium of Test Piece 18 manufactured using such a precision polishing step, there were no fine scratches, there was no polishing unevenness, and the TOH was 3.3 nm.

Test Piece 19

In the precision polishing step, a polishing member made of a resin having a 100% modulus of 12,740 kPa (130 kg/cm²), a polishing machine having a rotational speed of 0.2 per second (12 rpm), and slurry solids having as a principal component thereof cerium oxide having a mean particle diameter of 0.5 μm, a maximum particle diameter of 2.5 μm, and a content of particles having a particle diameter of at least 1 μm of 18 mass % of the slurry solids were used. For an information recording medium of Test Piece 19 manufactured using such a precision polishing step, there were no fine scratches, there was no polishing unevenness, and the TOH was 3.8 nm.

Comparative Test Piece 1

In the precision polishing step, a polishing member made of a resin having a 100% modulus of 4,900 kPa (50 kg/cm²), a polishing machine having a carrier rotational speed of 0.05 per second (3 rpm), and slurry solids having as a principal component thereof cerium oxide having a mean particle diameter of 1 μm, a maximum particle diameter of 2 μm, and a content of particles having a particle diameter of at least 1 μm of 3 mass % of the slurry solids were used. For an information recording medium of Comparative Test Piece 1 manufactured using such a precision polishing step, there were no fine scratches, there was no polishing unevenness, and the TOH was 6.2 nm.

Comparative Test Piece 2

In the precision polishing step, the same polishing machine and slurry solids as in Comparative Test Piece 1 were used, but a polishing member made of a resin having a 100% modulus of 5,880 kPa (60 kg/cm²) was used. For an information recording medium of Comparative Test Piece 2 manufactured using such a precision polishing step, there were no fine scratches, there was no polishing unevenness, and the TOH was 5.9 nm.

Comparative Test Piece 3

In the precision polishing step, the same polishing machine and slurry solids as in Comparative Test Piece 1 were used, but a polishing member made of a resin having a 100% modulus of 6,860 kPa (70 kg/cm²) was used. For an information recording medium of Comparative Test Piece 3 manufactured using such a precision polishing step, there were no fine scratches, there was no polishing unevenness, and the TOH was 5.1 nm.

Comparative Test Piece 4

In the precision polishing step, a polishing member made of a resin having a 100% modulus of 7,840 kPa (80 kg/cm²), a polishing machine having a carrier rotational speed of 0.0166 per second (1 rpm), and slurry solids having as a principal component thereof cerium oxide having a mean particle diameter of 1 μm, a maximum particle diameter of 2 μm, and a content of particles having a particle diameter of at least 1 μm of 3 mass % of the slurry solids were used. For an information recording medium of Comparative Test Piece 4 manufactured using such a precision polishing step, there were fine scratches, there was no polishing unevenness, and the TOH was 5.5 nm.

Comparative Test Piece 5

In the precision polishing step, the same polishing member made of the resin and slurry solids as in Comparative Test Piece 4 were used, but a polishing machine having a carrier rotational speed of 0.2833 per second (17 rpm) was used. For an information recording medium of Comparative Test Piece 5 manufactured using such a precision polishing step, there were fine scratches, there was no polishing unevenness, and the TOH was 5.0 nm.

### Comparative Test Piece 6

In the precision polishing step, the same polishing member made of the resin and slurry solids as in Comparative Test Piece 4 were used, but a polishing machine having a carrier rotational speed of 0.333 per second (20 rpm) was used. For an information recording medium of Comparative Test Piece 6 manufactured using such a precision polishing step, there were no fine scratches, there was polishing unevenness, and the TOH was 5.1 nm.

### Comparative Test Piece 7

In the precision polishing step, a polishing member made of a resin having a 100% modulus of 7,840 kPa (80 kg/cm²), a polishing machine having a carrier rotational speed of 0.0333 per second (2 rpm), and slurry solids having as a principal component thereof cerium oxide having a mean particle diameter of 0.05 μm, a maximum particle diameter of lam, and a content of particles having a particle diameter of at least 1 μm of 0.1 mass % of the slurry solids were used. For an information recording medium of Comparative Test Piece 7 manufactured using such a precision polishing step, there were no fine scratches, there was no polishing unevenness, and the TOH was 5.5 nm.

### Comparative Test Piece 8

In the precision polishing step, the same polishing member made of the resin as in Comparative Test Piece 7 was used, but a polishing machine having a carrier rotational speed of 0.15 per second (9 rpm), and slurry solids having as a principal component thereof cerium oxide having a mean particle diameter of 1.5 μm, a maximum particle diameter of 5 μm, and a content of particles having a particle diameter of at least 1 μm of 65 mass % of the slurry solids were used. For an information recording medium of Comparative Test Piece 8 manufactured using such a precision polishing step, there were no fine scratches, there was polishing unevenness, and the TOH was 5.7 nm.

Comparative Test Piece 9

In the precision polishing step, a polishing member made of a resin having a 100% modulus of 11,760 kPa(120 kg/cm²), a polishing machine having a carrier rotational speed of 0.1 per second (6 rpm), and slurry solids having as a principal component thereof cerium oxide having a mean particle diameter of 1.6 μm, a maximum particle diameter of 3.3 μm, and a content of particles having a particle diameter of at least 1 μm of 40 mass % of the slurry solids were used. For an information recording medium of Comparative Test Piece 9 manufactured using such a precision polishing step, there were no fine scratches, there was no polishing unevenness, and the TOH was 4.9 nm.

### Comparative Test Piece 10

In the precision polishing step, the same polishing member made of the resin and polishing machine as in Comparative Test Piece 9 were used, but slurry solids having as a principal component thereof cerium oxide having a mean particle diameter of 0.5 μm, a maximum particle diameter of 3.2 μm, and a content of particles having a particle diameter of at least 1 μm of 22 mass % of the slurry solids was used. For an information recording medium of Comparative Test Piece 10 manufactured using such a precision polishing step, there were fine scratches, there was no polishing unevenness, and the TOH was 4.8 nm.

### Comparative Test Piece 11

In the precision polishing step, a polishing member made of a resin having a 100% modulus of 7,840 kPa (80 kg/cm²), a polishing machine having a carrier rotational speed of 0.0666 per second (4 rpm), and slurry solids having as a principal component thereof cerium oxide having a mean particle diameter of 0.5 μm, a maximum particle diameter of 3.1 μm, and a content of particles having a particle diameter of at least lam of 18 mass % of the slurry solids were used. For an information recording medium of Comparative Test Piece 11 manufactured using such a precision polishing step, there were no fine scratches, there was no polishing unevenness, and the TOH was 5.3 nm.

According to Test Pieces 1 to 7 and Comparative Test Pieces 1 to 3, as shown in Tables 1 and 2 and FIG. 3, it can be seen from the relationship between the resin hardness expressed by the 100% modulus (kPa (kg/cm²)) and the maximum value of PSD×f (cm²), that to make the maximum value of PSD×f be not more than 1600 cm², which corresponds to the TOH being not more than 4.5 nm, the 100% modulus of the resin should be made to be in a range of 7,840 to 24,500 kPa (80 to 250 kg/cm²). Moreover, more preferably the 100% modulus of the resin is made to be in a range of 9,800 to 19,600 kPa (100 to 200 kg/cm²), whereby it can be seen that the maximum value of PSD×f can be made to be not more than 900 cm², which corresponds to the TOH being not more than 3.5 nm.

It is thought that the reasons for the above are as follows: the higher the value of the 100% modulus, the less prone to deformation the surface layer of the nap layer, and the lower the proportion of amorphous parts and the higher the proportion of crystalline parts in the molecular structure of the resin, i.e. the harder the surface layer of the nap layer in terms of microscopic structure, and therefore waviness components on the information recording surfaces of a workpiece can be substantially eliminated;

However, if the value of the 100% modulus of the resin is too large, then it is difficult for the foamed resin to be formed sufficiently homogeneously and flatly, and hence fine scratches become prone to occurring. That is, it is thought that the above is because, when the 100% modulus is in a range of 9,800 to 19,600 kPa (100 to 200 kg/cm²), the microscopic hardness of the surface layer of the nap layer is sufficiently high, but also the homogeneity is high, and hence waviness components can be eliminated to the greatest extent.

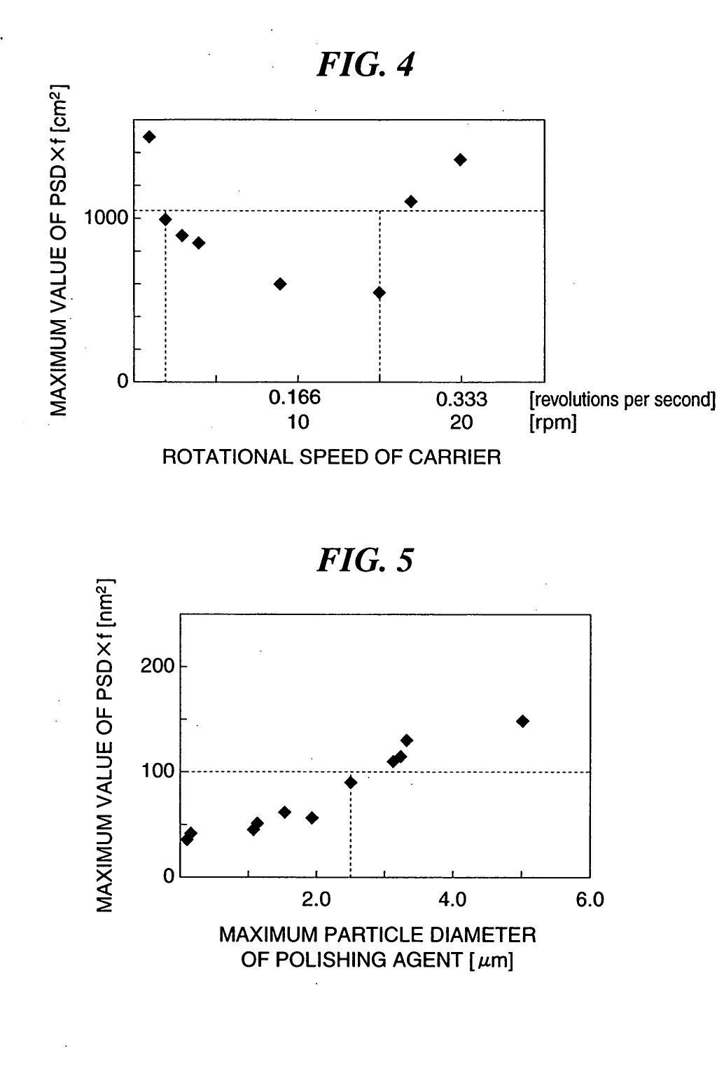

According to Test Pieces 8 to 12 and Comparative Test Pieces 4 to 6, as shown in Tables 1 and 3 and FIG. 4, it can be seen from the relationship between the rotational speed of the carrier (revolutions per second (rpm)) and the maximum value of PSD×f (cm²), that to make the maximum value of PSD×f be not more than 1100 cm², which corresponds to the TOH being not more than 4.5 nm, the rotational speed of the carrier should be made to be in a range of 0.0333 to 0.25 per second (2 to 15 rpm).

It is thought that this is because, if the rotational speed of the carrier is less than 0.0333 per second (2 rpm), then the time period for which the polishing pads precision-polish the workpiece in a given direction becomes relatively long, and hence waviness components of wavelength 10 to 50 μm become prone to occurring; moreover, if the rotational speed of the carrier exceeds 0.25 per second (15 rpm), then the burden on the polishing machine and/or the carrier becomes large, and hence the carrier can no longer rotate smoothly. Therefore, waviness components and/or fine scratches occur on the-surfaces of the workpiece.

Furthermore, according to Test Pieces 13 to 19 and Comparative Test Pieces 7 to 11, as shown in Tables 1 and 4 and FIG. 5, it can be seen from the relationship between the maximum particle diameter of the polishing agent (μm) and the maximum value of PSD×f (nm²), that to make the maximum value of PSD×f be not more than 100 nm², which corresponds to the TOH being not more than 4.5 nm, the maximum particle diameter of the polishing agent should be made to be not more than approximately 2.5 μm. As a result, waviness components can be substantially eliminated, and moreover the occurrence of polishing unevenness, fine scratches and so on can be prevented.

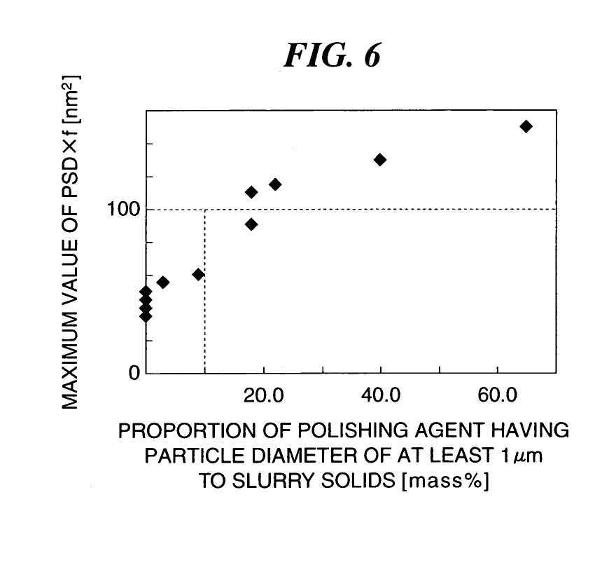

Moreover, as shown in Tables 1 and 4 and FIG. 6, it can be seen from the relationship between the proportion (mass %) of the polishing agent having a particle diameter of at least lam relative to the slurry solids and the maximum value of PSD×f (nm²), that to make the maximum value of PSD×f be not more than 100 nm², which corresponds to the TOH being not more than 4.5 nm, the content in the slurry solids of particles having a particle diameter in a range of approximately 1 to 2.5 μm should be made to be approximately 10% of the total mass of the slurry solids. As a result, waviness components can be substantially eliminated.

Furthermore, according to Test Pieces 17 to 19 and Comparative Test Piece 7, as shown in Table 1, it can be seen that in the case that the slurry containing fine particulate silica is used, even if the mean particle diameter and the maximum particle diameter of the silica are small, there is no polishing unevenness, i.e. agglomeration is not brought about.

A description will now be given of second examples. In the examination step S11 in FIG. 1, the surface shape of the test pieces of information recording medium according to the first examples in the vicinity of the circumferential texture in a region of area 0.1 mm to 5 mm square thereof (Test Pieces 1 to 7, Comparative Test Pieces 1 to 3) was measured over a predetermined wavelength ν range of 0.1 to 5 mm along the circumferential direction using a ZygoNewview optical interferometer, the mean waviness Wa (nm) was measured, and a study was carried out into the relationship between the mean waviness Wa (nm) and the TOH (nm), and the relationship between the maximum value of PSD×f (cm²) and the TOH (nm), for the test pieces. In the line analysis, measurement was carried out along the circumferential texture using a probe, the PS was extracted for 1024 lines, and the extraction results were averaged.

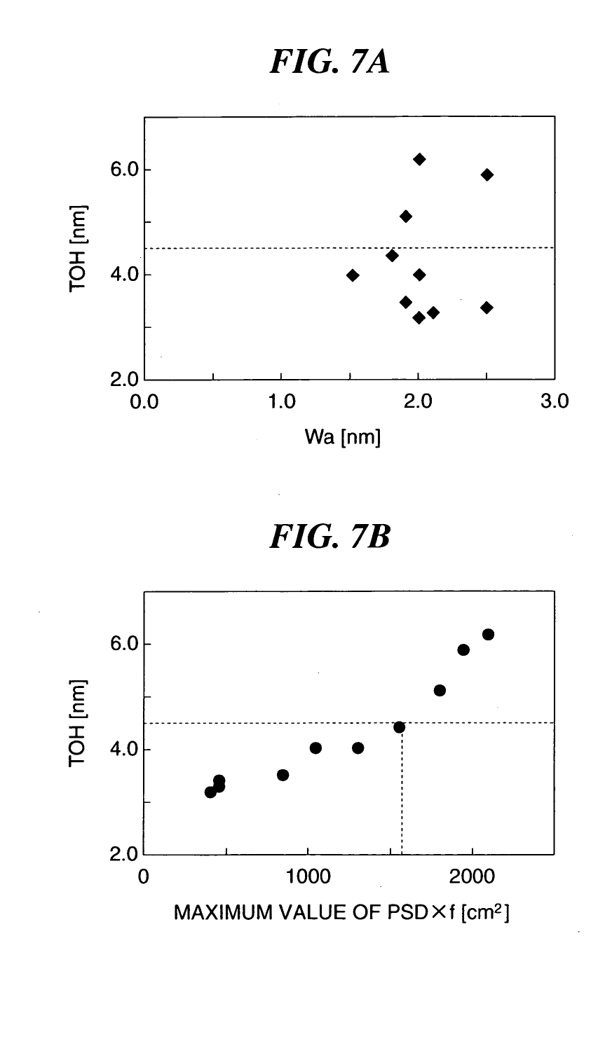

The measurement results are shown in Table 2 below, and FIGS. 7A and 7B.

TABLE 2

| | | | Maximum Value of | |
|---|---|---|---|---|
| | | Wa | PSD × f | TOH |
| | | [nm] | [cm²] | [nm] |
| Test Piece | 1 | 1.8 | 1550 | 4.4 |
| | 2 | 1.5 | 1300 | 4.0 |
| | 3 | 2.1 | 450 | 3.3 |
| | 4 | 2.0 | 400 | 3.2 |
| | 5 | 2.5 | 450 | 3.4 |
| | 6 | 1.9 | 850 | 3.5 |
| | 7 | 2.0 | 1050 | 4.0 |
| Comparative | 1 | 2.0 | 2100 | 6.2 |
| Test Piece | 2 | 2.5 | 1950 | 5.9 |
| | 3 | 1.9 | 1800 | 5.1 |

From the measurement results, it can be seen from the relationship between the mean waviness Wa and the TOH shown in FIG. 7A that there is no noticeable correlation whatsoever between Wa and the TOH, but in contrast it can be seen from the relationship between the maximum value of PSD×f and the TOH shown in FIG. 7B that there is a linear correlation between the maximum value of PSD×f and the TOH.

According to the second examples, there is a linear correlation between the maximum value of PSD×f and the TOH, and it can be seen that to obtain an information recording medium having a TOH of not more than 4.5 nm and hence excellent medium characteristics, the maximum value of PSD×f should be not more than 1600 cm². Moreover, the maximum value of PSD×f is more preferably not more than 1300 cm², whereby it can be seen that an information recording medium having a TOH of not more than 4.0 nm and hence even better medium characteristics can be obtained.

A description will now be given of third examples.

In the examination step S11 in FIG. 1, the surface shape of Test Pieces 8 to 12, Comparative Test Pieces 4 to 6 of information recording medium of the first examples in the vicinity of the circumferential texture in a region of area 10 μm to 200 μm square thereof was measured over a predetermined wavelength ν range of 10 to 200 μm along the circumferential direction using a ZygoNewview optical interferometer, the mean waviness Wa (nm) was measured, and a study was carried out into the relationship between the mean waviness Wa (nm) and the TOH (nm), and the relationship between the maximum value of PSD×f (cm²) and the TOH (nm), for the test pieces. In the line analysis, measurement was carried out along the circumferential texture using a probe, the PS was extracted for 256 lines, and the extraction results were averaged.

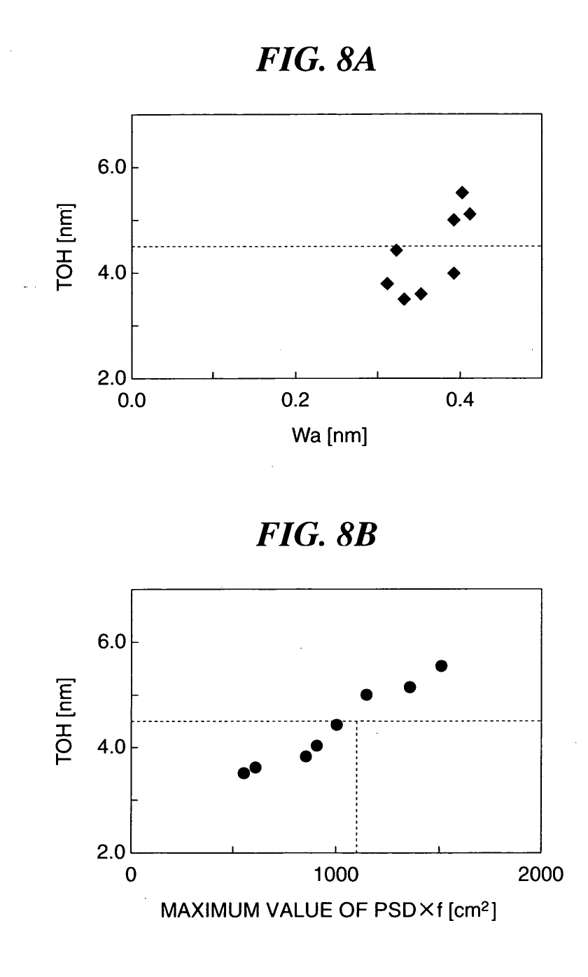

The measurement results are shown in Table 3 below, and FIGS. 8A and 8B.

TABLE 3

| | | | Maximum Value of | |
|---|---|---|---|---|
| | | Wa | PSD × f | TOH |
| | | [nm] | [cm²] | [nm] |
| Test Piece | 8 | 0.32 | 1000 | 4.4 |
| | 9 | 0.39 | 900 | 4.0 |
| | 10 | 0.31 | 850 | 3.8 |
| | 11 | 0.35 | 600 | 3.6 |
| | 12 | 0.33 | 550 | 3.5 |
| Comparative | 4 | 0.40 | 1500 | 5.5 |
| Test Piece | 5 | 0.39 | 1150 | 5.0 |
| | 6 | 0.41 | 1350 | 5.1 |

From the measurement results, it can be seen from the relationship between the mean waviness Wa and the TOH shown in FIG. 8A that there is no noticeable correlation whatsoever between Wa (nm) and the TOH (nm), but in contrast it can be seen from the relationship between the maximum value of PSD×f and the TOH shown in FIG. 8B that there is a linear correlation between the maximum value of PSD×f and the TOH.

According to the third examples, there is a linear correlation between the maximum value of PSD×f (cm²) and the TOH (nm), and it can be seen that to obtain an information recording medium having a TOH of not more than 4.5 nm and hence excellent medium characteristics, the maximum value of PSD×f should be not more than 1100 cm². Moreover, the maximum value of PSD×f is more preferably not more than 900 cm², whereby it can be seen that an information recording medium having a TOH of not more than 4.0 nm and hence even better medium characteristics can be obtained.

A description will now be given of fourth examples. In the examination step S11 in FIG. 1, the surface shape of Test Pieces 13 to 19, Comparative Test Pieces 7 to 11 of information recording medium of the first examples in the vicinity of the circumferential texture in a region of area 1 μm to 50 μm square thereof was measured over a predetermined wavelength ν range of 1 to 50 μm along the circumferential direction using the probe of a Nanocope IV atomic force microscope, the mean roughness Ra (nm) was measured, and a study was carried out into the relationship between the average roughness Ra (nm) and the TOH (nm), and the relationship between the maximum value of PSD×f (nm²) and the TOH (nm), for the test pieces.

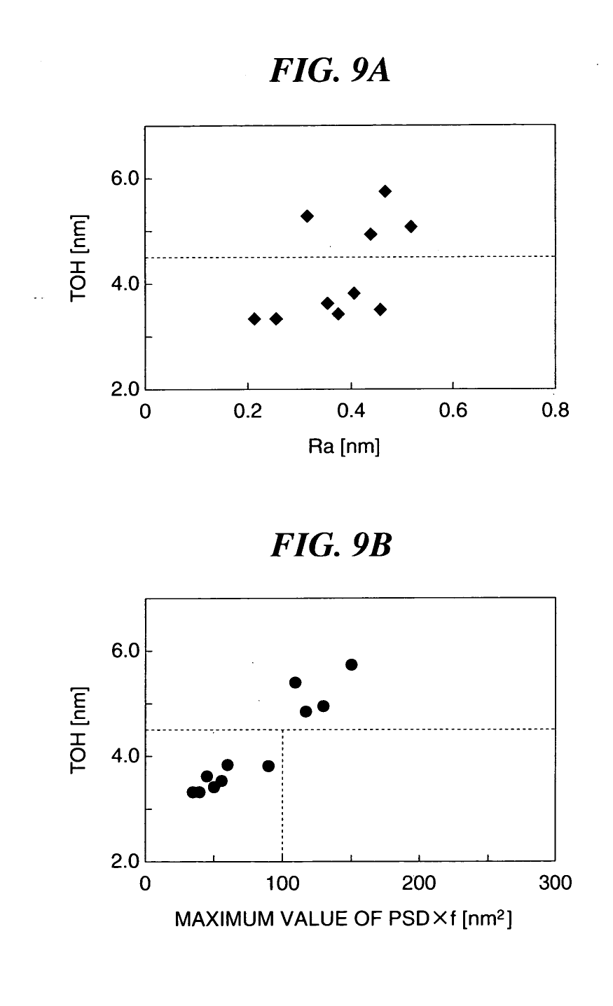

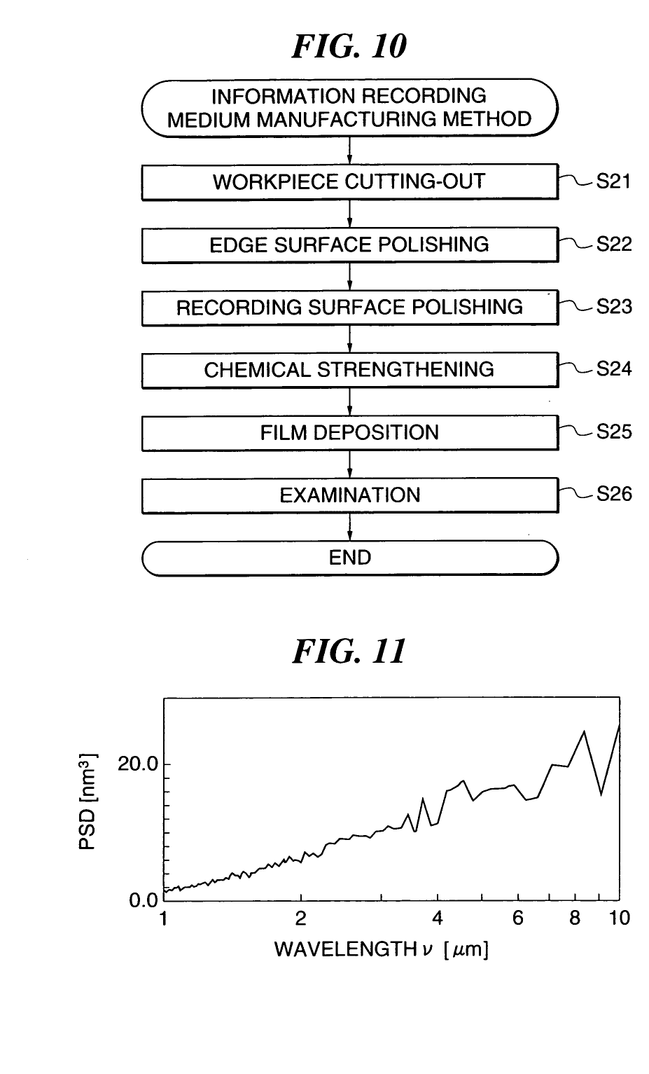

The measurement results are shown in Table 4 below, and FIGS. 9A and 9B.

TABLE 4

| | | | Maximum Value of | |
|---|---|---|---|---|
| | | Ra | PSD × f | TOH |
| | | [nm] | [nm²] | [nm] |
| Test Piece | 13 | 0.37 | 50 | 3.4 |
| | 14 | 0.45 | 55 | 3.5 |
| | 15 | 0.40 | 60 | 3.8 |
| | 16 | 0.35 | 45 | 3.6 |
| | 17 | 0.21 | 35 | 3.3 |
| | 18 | 0.25 | 40 | 3.3 |
| | 19 | 0.40 | 90 | 3.8 |
| Comparative Test | 7 | | | 5.5 |
| Piece | 8 | 0.46 | 150 | 5.7 |
| | 9 | 0.50 | 130 | 4.9 |
| | 10 | 0.43 | 115 | 4.8 |
| | 11 | 0.31 | 110 | 5.3 |

From the measurement results, it can be seen from the relationship between the mean roughness Ra (nm) and the TOH shown in FIG. 9A that there is no noticeable correlation whatsoever between Ra and the TOH, but in contrast it can be seen from the relationship between the maximum value of PSD×f and the TOH shown in FIG. 9B that there is a linear correlation between the maximum value of PSD×f and the TOH.

According to the fourth examples, there is a linear correlation between the maximum value of PSD×f (nm²) and the TOH (nm), and it can be seen that to obtain an information recording medium having a TOH of not more than 4.5 nm and hence excellent medium characteristics, the maximum value of PSD×f should be not more than 100 nm². Moreover, the maximum value of PSD×f is more preferably not more than 80 nm², whereby it can be seen that an information recording medium having a TOH of not more than 4.0 nm and hence even better medium characteristics can be obtained.

It is thought that the reason, in the second to fourth examples, that the TOH drops if the maximum value of PSD×f drops is that there is an effect of reducing obstacles in the head flying direction. In contrast, it is thought that the reason that no correlation could be found between the mean waviness Wa or the mean roughness Ra (nm), which are average values, and the TOH is that waviness components in directions other than the head flying direction are incorporated into the mean waviness Wa and the mean average roughness Ra (nm).

1. An information recording medium comprising a substrate, and at least one recording layer formed on said substrate;
wherein said at least one recording layer has a surface shape thereof measured at a predetermined wavelength in a predetermined region of a surface thereof, and a maximum value of a product of a power spectral density corresponding to the predetermined wavelength and a reciprocal of the predetermined wavelength is not more than a predetermined value.

2. An information recording medium as claimed in claim 1, wherein the surface shape is measured using an interferometer and wherein the predetermined region has an area in a range of 0.1 mm to 5 mm square, and the predetermined value is not more than 1600 cm².

3. An information recording medium as claimed in claim 2, wherein the predetermined value is not more than 1300 cm².

4. An information recording medium as claimed in claim 1, wherein the predetermined region has an area in a range of 10 μm to 200 μm square, and the predetermined value is not more than 1100 cm².

5. An information recording medium as claimed in claim 4, wherein the predetermined value is not more than 900 cm².

6. An information recording medium as claimed in claim 1, wherein the surface shape is measured by scanning the surface of said at least one recording layer with a probe of an atomic force microscope, and wherein the predetermined region has an area in a range of 1 μm to 50 μm square, and the predetermined value is not more than 100 nm².

7. An information recording medium as claimed in claim 6, wherein the predetermined value is not more than 80 nm².

8. An information recording medium as claimed in claim 1, wherein said substrate has a main surface, and circumferential texture is formed on said at least one recording layer or the main surface of said substrate.

9. A method of manufacturing a glass substrate for information recording media, the glass substrate having at least one recording layer formed thereon, comprising:
a polishing step of polishing at least one surface of a glass substrate using at least one polishing member made of a processed resin having a 100% modulus in a range of 7,840 to 24,500 kPa (80 to 250 kg/cm²), wherein the 100% modulus represents a force required for extending a test piece having a cross sectional area of 1 cm² to twice a length of the test piece.

10. A method of manufacturing a glass substrate for information recording media as claimed in claim 9, wherein the at least one polishing member is rotated at 0.0333 to 0.25 per second (2 to 15 rpm).

11. A method of manufacturing a glass substrate for information recording media as claimed in claim 9, wherein in said polishing step, a slurry containing a polishing agent that has a maximum particle diameter in a range of 1 to 3 μm is used.

12. A method of manufacturing a glass substrate for information recording media as claimed in claim 9, wherein in said polishing step, a slurry containing a polishing agent that has a content of particles having a maximum particle diameter in a range of 1 to 3 μm of not more than 10% of mass of slurry solids is used.

13. A method of manufacturing a glass substrate for information recording media as claimed in claim 9, wherein in said polishing step, a slurry containing silica having a particle diameter in a range of 0.01 to 1 μm is used.

14. A method of manufacturing a glass substrate for information recording media as claimed in claim 9, wherein the at least one polishing member made of a processed resin having a 100% modulus in a range of 9,800 to 19,600 kPa (100 to 200 kg/cm²).

15. A glass substrate for information recording media manufactured by a method of manufacturing a glass substrate for information recording media as claimed in claim 9,
wherein the at least one recording layer has a surface shape thereof measured at a predetermined wavelength in a predetermined region of a surface thereof, and a maximum value of a product of a power spectral density corresponding to the predetermined wavelength and a reciprocal of the predetermined wavelength is not more than a predetermined value.

16. A glass substrate for information recording media as claimed in claim 15, wherein the surface shape is measured using an interferometer and wherein the predetermined region has an area in a range of 0.1 mm to 5 mm square, and the predetermined value is not more than 1600 cm².

17. A glass substrate for information recording media as claimed in claim 16, wherein the predetermined value is not more than 1300 cm².

18. A glass substrate for information recording media as claimed in claim 15, wherein the predetermined region has an area in a range of 10 μm to 200 μm square, and the predetermined value is not more than 1100 cm².

19. A glass substrate for information recording media as claimed in claim 18, wherein the predetermined value is not more than 900 cm².

20. A glass substrate for information recording media as claimed in claim 15, wherein the surface shape is measured by scanning the surface of said at least one recording layer with a probe of an atomic force microscope, and wherein the predetermined region has an area in a range of 1 μm to 50 μm square, and the predetermined value is not more than 100 nm².

21. A glass substrate for information recording media as claimed in claim 20, wherein the predetermined value is not more than 80 nm².

22. A glass substrate for information recording media as claimed in claim 15, wherein the substrate has a main surface, and circumferential texture is formed on said at least one recording layer or the main surface of the substrate.
